(19) United States
(12) Patent Application Publication
(10) Pub. No.: US 2026/0057438 A1
(43) Pub. Date: Feb. 26, 2026

(54) System and Method For Leveraging Homeowner's Equity In Income-Generating Investments

(71) Applicant: Piage Afshar, Tustin, CA (US)

(72) Inventor: Piage Afshar, Tustin, CA (US)

(21) Appl. No.: 19/306,942

(22) Filed: Aug. 21, 2025

Related U.S. Application Data
(60) Provisional application No. 63/685,362, filed on Aug. 21, 2024.

(51) Int. Cl. G06Q 40/03; G06Q 40/06

(52) U.S. Cl. CPC G06Q 40/036; G06Q 40/063

(57) ABSTRACT

A method, including receiving client information and data on a plurality of income-producing assets, generating a plurality of equity contracts and client risk factors based on the client information, retrieving equity of a first real estate property in response to execution of at least one of the plurality of equity contracts by a first external computing device, selecting and funding at least one of the plurality of income-producing assets with the equity based on the client risk factors, and deducting at least a portion of revenue from at least one of the plurality of income-producing assets as an interest payment.

### CROSS-REFERENCE TO RELATED APPLICATION

This application incorporates by reference and claims the benefit of priority to U.S. Provisional Application 63/685,362 filed on Aug. 21, 2024.

### BACKGROUND OF THE INVENTION

### 1. Field of the Invention

The present disclosure relates to a system and method for enabling property owners to leverage their home equity for investments in income-producing assets, offering various interest options and mortgage coverage alternatives.

### 2. Description of the Related Art

Few individuals have enough savings or liquid funds to enable them to purchase property outright and it is normal practice for property or home purchases to be funded by a mortgage loan. Many consumers/borrowers that purchase a home borrow funds from a lender and grant the lender a security interest in the home, which serves as collateral. The legal document whereby the consumer uses the property as collateral for repayment of the loan is commonly known as a mortgage or mortgage loan or promissory note.

Presently, property owners and holders of other types of property cannot extract funds from equity without incurring debt or selling their home or moving to another house. Therefore, it would be advantageous to provide property owners with an option that would allow them to obtain money based on the equity in their properties without incurring debt, and that would preferably allow them to continue to live in or otherwise use/occupy their properties with the same or similar degree of control as previously existed and with the same or similar degree of tax benefits. It would also be advantageous to provide property owners with a new kind of investment that is based on partial interests in assets that could be separately held or bundled with other partial interests and which could then be traded, for income-producing assets.

Further, the option of obtaining money based on equity in real estate is well known. This option is often taken by property owners looking for ways to finance college tuition, make home improvements, or satisfy other needs or interests. The traditional way of obtaining money from equity in property involves applying for a loan, paying processing fees, and making payments with interest to the lienholder for the life of the loan. Obtaining loans, or other forms of debt, can have a beneficial effect in terms of establishing a favorable credit report. However, incurring additional debt can prove to be burdensome, especially when interest rates are high.

Thus, there is a need for property owners to obtain money based on equity without incurring interest. There is also a need for property owners to obtain mortgage relief without incurring interest. And finally, there is also a need for property owners to leverage home equity for obtaining income-generating asset and receive return on investment after mortgage relief.

Additionally, there is a need for systems that integrate insurance-based accumulation strategies, including permanent life insurance contracts that offer cash value growth, dividend participation, or policy loans. These structures provide access to compounding value which may be utilized to support mortgage repayment or capital reinvestment, offering an alternative to traditional banking instruments.

### SUMMARY OF THE INVENTION

The present disclosure provides a system and method for leveraging home equity as investments in income-producing assets.

The foregoing and/or other features and utilities of the present disclosure may be achieved by providing a method, including receiving client information and data on a plurality of income-producing assets, generating a plurality of equity contracts and client risk factors based on the client information, retrieving equity of a first real estate property in response to execution of at least one of the plurality of equity contracts by a first external computing device, selecting and funding at least one of the plurality of income-producing assets with the equity based on the client risk factors, and deducting at least a portion of revenue from at least one of the plurality of income-producing assets as an interest payment.

The generating the plurality of equity contracts includes generating the plurality of equity contracts that includes at least one of a mortgage term and an interest term.

Each of the mortgage term and the interest term ranges from 0 to 2.99%. The generating the client risk factors includes generating client risk factors based on tolerance to volatility.

The data on the income-producing assets includes at least one of liquidity, principal protection, expected returns, cash flow, and arbitrage opportunities.

The selecting at least one of the plurality of income-producing assets includes generating a risk grade based on the data on the plurality of income-producing assets, and selecting at least one of the plurality of income-producing assets with the risk grade based on the client risk factors and an interest term.

The method further includes matching client risk factors from at least one second external computing device, retrieving equity of a second real estate property in response to execution of at least one of the plurality of equity contracts by the second external computing device, and funding at least one of the plurality of income-producing assets with the equity from the first external computing device and the second external computing device.

The deducting at least a portion of revenue includes reducing a mortgage term to zero based on the revenue generated from at least one of the plurality of income-producing assets.

The foregoing and/or other features and utilities of the present disclosure may also be achieved by providing a system, including one or more processing units, the one or more processing units configured to receive client information and data on a plurality of income-producing assets, generate a plurality of equity contracts and client risk factors based on the client information, retrieve equity of a first real estate property in response to execution of at least one of the plurality of equity contracts by a first external computing device, select and fund at least one of the plurality of income-producing assets with the equity based on the client risk factors, and deduct at least a portion of revenue from at least one of the plurality of income-producing assets as an interest payment.

The one or more processing units are configured to generate the plurality of equity contracts to include at least one of a mortgage term and an interest term.

The one or more processing units are configured to limit each of the mortgage term and the interest term ranges from 0 to 2.99%. The one or more processing units are configured to generate client risk factors based on tolerance to volatility.

The one or more processing units are configured to identify the data on the income-producing assets to include at least one of liquidity, principal protection, expected returns, cash flow, and arbitrage opportunities.

The one or more processing units are configured to generate a risk grade based on the data on the plurality of income-producing assets, and select at least one of the plurality of income-producing assets with the risk grade based on the client risk factors and an interest term.

The one or more processing units are further configured to match client risk factors from at least one second external computing device, retrieve equity of a second real estate property in response to execution of at least one of the plurality of equity contracts by the second external computing device, and fund at least one of the plurality of income-producing assets with the equity from the first external computing device and the second external computing device.

The one or more processing units are configured to deduct at least a portion of revenue comprises reducing a mortgage term to zero based on the revenue generated from at least one of the plurality of income-producing assets.

The foregoing and/or other features and utilities of the present disclosure may also be achieved by providing a method, including generating an interest free mortgage based on receipt of at least one contract from at least one external computing device, generating an equity loan of at least one real estate property based on a difference in value between a market value of the at least one real estate property and the interest free mortgage, funding at least one of plurality of income-producing assets from the equity loan in response to at least one of the plurality of income-producing assets having a return on investment (ROI) exceeding a threshold value, and transferring at least a portion of the ROI to pay an interest payment on at least one of the interest free mortgage and the equity loan.

The generating the interest free mortgage includes adjusting a payment of principal on the interest free mortgage based on a risk factor.

The risk factor is at least one of a credit score and the difference in value between the market value of the at least one real estate property and the interest free mortgage.

The method further including receiving a rebate based on the equity loan, and generating a life insurance policy assigned to the at least one external computing device.

Before explaining the various embodiments of the invention in detail, it is to be understood that the invention is not limited in its application to the details of construction and to the arrangements of the components set forth in the following description or illustrated in the drawings. Rather, the invention is capable of other embodiments and of being practiced and carried out in various ways. Also, it is to be understood that the terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

For a better understanding of the invention, its operating advantages and the specific objects attained by its uses, reference should be made to the accompanying drawings and descriptive matter in which there are illustrated preferred embodiments of the invention.

Various objects, features, aspects and advantages of the present embodiment will become more apparent from the following detailed description of embodiments of the embodiment, along with the accompanying drawings in which like numerals represent like components.

### BRIEF DESCRIPTION OF THE DRAWINGS

It should be noted that the drawing figures may be in simplified form and might not be to precise scale.

FIG. 1 is a block diagram of the system for enabling property owners to leverage their home equity for investments in income-producing assets in accordance with some embodiments.

FIG. 2 is a block diagram of the system for enabling property owners to leverage their home equity for investments in income-producing assets in accordance with some embodiments.

FIG. 3 is a block diagram of the system for enabling property owners to leverage their home equity for investments in income-producing assets in accordance with some embodiments.

FIG. 4 is a block diagram of the system for enabling property owners to leverage their home equity for investments in income-producing assets in accordance with some embodiments.

FIG. 5 is a block diagram of the system for enabling property owners to leverage their home equity for investments in income-producing assets in accordance with some embodiments

FIG. 6 is a flow diagram illustrating a method for leveraging home equity for investments in an income-producing asset in accordance with some embodiments.

FIG. 7 is a flow diagram illustrating a method for leveraging home equity to generate returns in a life insurance policy in accordance with some embodiments.

FIG. 8 is a flow diagram illustrating a method for transferring payments for a mortgage to a life insurance policy and generating returns on the life insurance policy in accordance with some embodiments.

### DETAILED DESCRIPTION OF THE INVENTION

The embodiment and various other embodiments can now be better understood by turning to the following detailed description of the embodiments, which are presented as illustrated examples of the embodiment defined in the claims. It is expressly understood that the embodiment as defined by the claims may be broader than the illustrated embodiments described below. Many alterations and modifications may be made by those having ordinary skill in the art without departing from the spirit and scope of the embodiments.

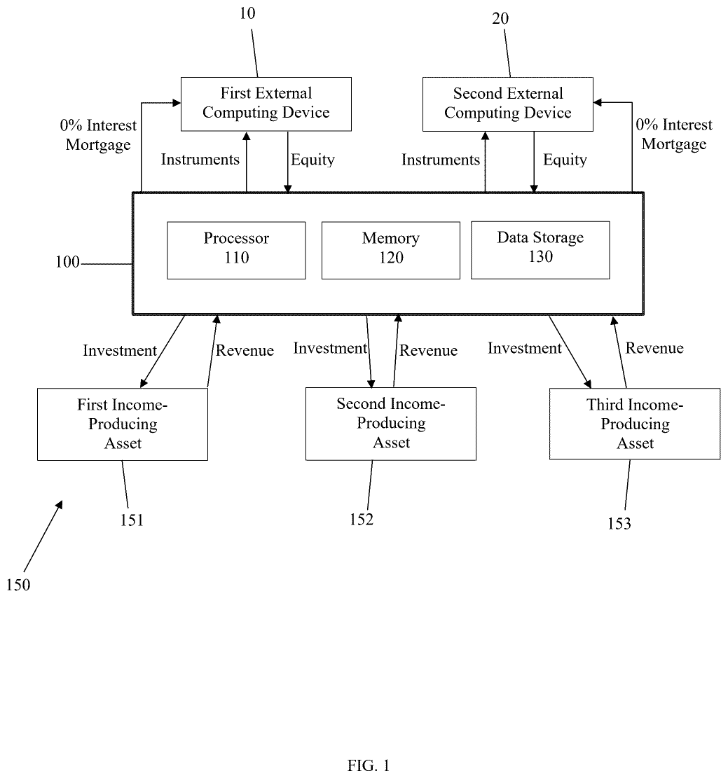

FIG. 1 is a block diagram showing a system 100 for enabling property owners to leverage their home equity for investments in income-producing assets in accordance with some embodiments. In some embodiments, the system 100 includes a processor 110, a memory 120, and a data storage 130, but is not limited thereto. In some embodiments, the processor 110 includes a central processing unit (CPU), inference engines, machine-learning processors, other multithreaded processing units, scalar processors, serial processors, programmable logic devices (simple programmable logic devices, complex programmable logic devices, field programmable gate arrays (FPGAs)), or any combination thereof. Moreover, the processor 110 is a processing unit that executes instructions, operations, or both based on a program. In other embodiments, the processor 110 is a plurality of processors 110, which are not shown in the interest of clarity. That is, in other embodiments, the system 100 has the plurality of processors 110 to execute instructions and/or operations. Alternatively, and/or in addition thereto, in other embodiments, the processor 110 includes one or more processor cores that execute instructions concurrently or in parallel.

The memory 120 is a transitory storage component such as, for example, a dynamic random-access memory (DRAM). However, in other embodiments, the memory 120 includes other types of memory such as, for example, static random-access memory (SRAM), and the like. The memory 120 further includes a memory controller, not shown for clarity. The memory controller facilitates the flow of data between the one or more processing units and the memory 120. Additionally, the memory controller manages read and/or write operations within memory while correcting errors (e.g., error correction) for detected errors in the memory 120. According to some embodiments, the memory 120 includes an external memory disposed external to the processor 110 in the system 100. The memory 120 stores information or data in memory including results of any executed instructions or operations based on the program.

In some embodiments, the data storage 130 includes any non-transitory storage medium. For example, the data storage 130 includes a hard drive, an optical drive (e.g., compact disc (CD), digital versatile disc (DVD), Blu-Ray disc), non-volatile memory (e.g., read-only memory (ROM), Flash memory), and the like. In some embodiments, the data storage 130 is disposed within the system 100, connected to the system 100 via an external port, removably connected to the system 100, or a cloud-based storage unit connected via a wireless or hardwired network.

In some embodiments, the data storage 130 stores digital data including preferences of a first external computing device 10 and a second external computing device 20 (e.g., property owner clients), such as desktop computers, laptop computers, tablet computers, cellular phone, personal digital assistants, and the like. The data storage 130 stores investment preferences (such as preferred investment risk preferences) and bank account information for the first external computing device 10 and/or the second external computing device 20. Additionally, the data storage 130 stores information on types of income-producing assets such as liquidity, principal protection, expected returns, cash flow, and arbitrage opportunities. The above-mentioned income-producing assets include stock/equities, bonds, real estate, Real Estate Investment Trust (REIT), farmland, businesses, franchise, certificate of deposit (CD), money market funds, royalties, acquisitions, mutual funds, exchange traded funds (ETF), etc. The income-producing investment vehicles may include, but are not limited to: permanent life insurance contracts (e.g., Whole Life, IUL, VUL), annuities, private placement insurance products (PPLI), structured notes, tokenized securities, private equity placements, pooled real estate investment vehicles, special purpose vehicles (SPVs), qualified plans, digital assets, and future-developed capital structures. The invention is not limited to any single financial product and is intended to support emerging and decentralized financial instruments.

In some embodiments, the program includes artificial intelligence (AI). In particular, the processor 110 executes the program and is controlled by the AI to perform all the functions described herein. Further, the AI may be trained on numerous data sets, investment strategies, machine learning, deep learning operations, and the like. Also, the first external computing device 10 and/or the second external computing device 20 execute instructions via the program and AI, such that the steps performed by the first external computing device 10 and/or the second external computing device 20 are executed by the AI based on interactions with the processor 110.

Additionally, in some embodiments, the income-producing assets includes insurance-backed financial contracts with accumulation features or permanent life insurance contracts, such as Indexed Universal Life (IUL), Whole Life (WL), Variable Universal Life (VUL), or a future-developed equivalent. In some embodiments, the processor 110 generates insurance-backed contract as a capital deployment vehicle. That is, the capital deployment vehicle includes returns on investments, dividends, and/or growth, such that the processor 110 transfers funds based on the insurance-backed financial contract to reduce mortgage obligations, support investment operations, and/or generate long-term wealth transfer. For example, the processor 110 initiates a life insurance policy loan or equivalent advance based on the insurance contract at a loan-to-value ratio determined by carrier guidelines. The processor 110 extracts premium payments from the first external computing device 10 and/or the second external computing device 20. Based on the insurance contract, the first external computing device 10 and/or the second external computing device 20 pay monthly premiums, annual premiums, 7-pay structures, single premium, or minimum qualifying premium contributions. In this variation, the processor 110 pays off the mortgage balance of the first external computing device 10 and/or the second external computing device 20, and the first external computing device 10 and/or the second external computing device 20 subsequently pays premiums (monthly, annually, or via lump sum) into a life insurance or hybrid financial product. The life insurance policy's cash value, dividends, or indexed growth components are used in lieu of traditional mortgage payments. These funds may be reinvested, collateralized, or allowed to compound over time. The processor 110 implements this model to accommodate client-elected participation or passive reinvestment, providing repayment flexibility, wealth accumulation, or mortgage offsetting through life-insurance-based instruments.

The processor 110 is electrically connected to the data storage 130 to retrieve data from and store data in the data storage 130. Based on instructions from the program, the processor 110 executes instructions to receive selections from the first external computing device 10 and the second external computing device 20. The processor 110 retrieves information on the property owner client's agreement from the first external computing device 10 and/or the second external computing device 20. In response to receiving the property owner client's agreement from the first external computing device 10 and/or the second external computing device 20, the processor 110 extracts the home equity of the first external computing device 10 and/or the second external computing device 20 from the data storage 130 to invest in some of the above-mentioned income-producing assets. The agreement includes a contractual instrument that transfers home equity to the system 100 and includes various terms such as interest payment. Client agreements may be structured through a wide variety of instruments, including but not limited to: land contracts, lien-holding agreements, collateral assignments, land trusts, installment sale agreements, equity sharing contracts, securitized note offerings, convertible debentures, hybrid promissory notes, joint ventures, subscription agreements, SPVs, or pooled investment structures. More specifically, the processor 110 generates an equity loan (e.g., a home equity loan) based on a difference in value between a market value for a real estate property (e.g., the home) and an outstanding balance on an existing mortgage (i.e., money owed on the real estate property). Moreover, the processor 110 generates the equity loan in response to the contract and/or agreement executed by the first external computing device 10 and/or the second external computing device 20, a risk factor, and/or a time period based on a particular month (e.g., January, February, March, April, etc.), season (e.g., spring, summer, fall, winter), state of origination (e.g., New York, Florida, California, Texas, etc.), any other factors, and/or any combination thereof. Alternatively, and/or in addition thereto, the processor 110 generates an equity line of credit (e.g., a line of credit based on value of the equity and may or may not include interest) and/or a cash-out refinance (e.g., a new mortgage with a larger balance based on the value of equity above the balance of the existing mortgage). Furthermore, the processor 110 accesses the equity through purchase, refinance, trust transfer, land contract, assignment of beneficial interest, or other legal mechanisms allowing economic control or beneficial use of the property.

The processor 110 tracks the value of the equity loan for the first external computing device 10 and/or the second external computing device 20. In some embodiments, the processor 110 generates at least four options for the first external computing device 10 and/or the second external computing device 20 based on the property owner client's agreement. The first option involves a zero percent (0%) interest loan product to the client corresponding to utilization of the equity of the client's property by the processor 110. The second option involves interest with variable rate paid to the client, preferably ranging from zero to fifteen percent (0%-15%), based on performance of the income-producing assets and client preferences such as investment risk preferences. The third option involves mortgage coverage by the system 100 to partially or fully cover the current mortgage in exchange for the use of equity on the real estate property toward income-producing assets. The fourth option presents a mortgage product at 0%-2.99% interest that would cover the interest portion entirely, principle coverage, or partial principal and interest payment coverages. The processor 110 adjusts the proportion of coverage based on interest rate selected by the external computing device.

In the depicted example of FIG. 1, the system 100 is connected to a plurality of income-producing assets 150. In some embodiments, the plurality of income-producing assets 150 includes a first income-producing asset 151, a second income-producing asset 152, and a third income-producing asset 153, but is not limited thereto. However, in different embodiments, the plurality of income-producing assets 150 includes less than three or more than three income-producing assets. Each of the plurality of income-producing assets 150 is a computing device or dedicated hardware. Alternatively, and/or in addition thereto, each of the plurality of income-producing assets 150 includes a hardware accelerator. That is, in other embodiments, each of the plurality of income-producing assets 150 has are hardware accelerators that execute instructions and/or operations. Alternatively, and/or in addition thereto, in other embodiments, each of the plurality of income-producing assets 150 includes one or more processor cores that execute instructions concurrently or in parallel. Further, in different embodiments, each of the plurality of income-producing assets 150 includes vector processors, coprocessors, non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs)), or any combination thereof. Each of the plurality of income-producing assets 150 includes at least one of the aforementioned income-producing assets described above. For example, the first income-producing asset 151 is a stock investment that includes a growth-focused stock and/or a dividend-focused stock, the second income-producing asset 152 is a bond, and the third income-producing asset 153 is a mutual fund.

After retrieving the equity from the first external computing device 10 and/or the second external computing device 20, the processor 110 changes the equity and redirects the funds into one or more capital deployment vehicles via at least one of the plurality of income-producing assets 150. Specifically, the processor 110 transfers the equity (i.e., funds) into insurance-based accumulation products, annuity contracts, investment portfolios, tokenized assets (e.g., cryptocurrency, non-fungible tokens (NFT)), structured notes, or equivalents. Each of the plurality of income-producing assets 150 generates capital appreciation, recurring yield, and/or borrowing facilities.

The processor 110 generates revenue based on a contractual agreement. For example, the processor 110 generates revenue by combining a land trust (i.e., a type of trust, a legal entity created to hold and manage land for development and/or investment) and a land contract (i.e., a contract for deed) together. The processor 110 invests funds from the equity loan on the real estate property to obtain ownership in income-producing assets. The instrument also includes land trust for property ownership in order to hold and manage properties on behalf of beneficiaries, who are typically the property owners or investors. The land trusts provide a secure way to hold title to the properties while allowing the property owner client to benefit from ownership rights, such as occupancy and appreciation. Also, the processor 110 monitors the plurality of income-producing assets 150 to maximize revenue (e.g., best outcome or return) and adjusts investments to another at least one of the plurality of income-producing assets 150. To illustrate via an example, the processor 110 monitors each of the plurality of income-producing assets 150, and presently the equity of the first external computing device 10 and/or the second external computing device 20 is invested in the first income-producing asset 151. However, the processor 110 transfers the equity of the first external computing device 10 and/or the second external computing device 20 to invest in the second income-producing asset 152 and/or the third income-producing asset 153 in response to an increased return (e.g., higher dividends, and/or growth, interest crediting, surrender value, etc.) from the second income-producing asset 152 and/or the third income-producing asset 153 with respect to the first income-producing asset 151.

The processor 110 generates the land contract for financing and offers options to the first external computing device 10 and/or the second external computing device 20 for the purchase or refinance of properties held within the land trusts. The first external computing device 10 and/or the second external computing device 20 acquires or retains properties through installment payments over time, similar to a rent-to-own arrangement, while the properties remain within the protective structure of the land trusts, upon full repayment the grant deed gets reverted back to the property owners, such as a traditional mortgage in a sense.

The processor 110 generates the income-producing assets in response to receiving at least one selection from the first external computing device 10 and/or the second external computing device 20 regarding optimization of the equity on the real estate property as well as investment risk preferences (risk-averse, risk-neutral, and risk-seeking). Furthermore, the processor 110 includes the information from the first external computing device 10 and/or the second external computing device 20 on the client's preferences (e.g., repayment time line) and/or the above-mentioned interest payment (e.g., zero up to fifteen percent) for the mortgage product.

In some embodiments, the processor 110 analyzes the data on the income-producing assets stored in the data storage 130 and determines the risk associated with the income-producing assets, wherein the data includes at least liquidity, principal protection, expected returns, cash flow, and arbitrage opportunities. Based on the analysis, the processor 110 assigns a risk grade for each of the income-producing assets, such that the processor 110 selects the income-producing asset that matches the preferences of the first external computing device 10 and/or the second external computing device 20 (i.e., client) and customizes the mortgage term and/or the interest term based on a tolerance to risk of the first external computing device 10 and/or the second external computing device 20.

For example, if the first external computing device 10 and/or the second external computing device 20 indicate a risk-averse risk preference and/or the Return On Investment (ROI) or interest to be paid to the client is low, then the processor 110 will invest the equity from the first external computing device 10 and/or the second external computing device 20 on the real estate property in income-producing assets that are relatively conservative such as bonds or an exchange-traded fund (ETF). In another example, if the first external computing device 10 and/or the second external computing device 20 embraces a risk-seeking risk preference and/or the ROI or interest to be paid to the property owner client is relatively high and between 0-15%, then the processor 110 invests the equity from the first external computing device 10 and/or the second external computing device 20 on mortgage products at 0-2.99% with options to cover any portion of the debt servicing in any combination, based on higher tolerance to risk. As such, the processor 110 invests the client's equity on the real estate property in income-producing assets that are relatively risky such as stock/equities and real estate, and any other investment producing assets and vehicles etc.

In summary, the system 100 uses the revenue generated from the plurality of income-producing assets 150 (acquiring through leveraging the equity on the real estate property of property owner clients) to cover interest payments or ROI on the funds used as collateral. This ensures that the obligations to the clients are met while the clients also continue to make principal and/or interest payments under the land contracts. Any excess revenue generated beyond payments to clients can be allocated for additional investments, operating expenses, or distributed to stakeholders (or shareholders or retained on balance sheet). Furthermore, the revenue generated from the capital vehicles of the plurality of income-producing assets 150, such as dividends, interest crediting, and/or surrender value (i.e., life insurance policy) are directed by the processor 110 to offset interest, principal, and/or other mortgage-related obligations based on configuration of the agreements and/or contracts.

As illustrated in FIG. 1, the system 100 is configured to interact with the first external computing device 10 and/or the second external computing device 20 (e.g., a plurality of property owner clients) each having different equity on the real estate property and preferences regarding investment and equity transfer arrangement. The system 100 of the present embodiment can also pool equity on the real estate property of the first external computing device 10, the second external computing device 20, and/or any other external computing device with similar investment preferences together in order to acquire income-producing assets that match the investment preferences or other preferences of said group of like-minded property owner clients. For example, if the first external computing device 10 and/or the second external computing device 20 indicate a risk-averse risk preference and/or the interest to be paid from the client is 0%. Then the processor 110 can pool their equity on the real estate property and use the resultant equity pool to invest the equity from the first external computing device 10 and/or the second external computing device 20 on the real estate property in income-producing assets that are relatively conservative such as bonds or exchange-traded funds (ETF). On the other hand, if the first external computing device 10 and/or the second external computing device 20 indicate a risk-seeking risk preference and/or the interest to be paid to the first external computing device 10 and/or the second external computing device 20 indicate can be set relatively high at 2.5% or ROI given to the client set at 0-15%. In some embodiments, the processor 110 identifies mortgage products with interest ranging between 0-2.99% to not receive an ROI, on a case by case basis. Accordingly, the processor 110 selects the first external computing device 10 and/or the second external computing device 20 to receive a mortgage product that has little to no interest and will be due on the debt servicing of that loan product. Then the processor 110 can pool equity for the first external computing device 10 and/or the second external computing device 20 on the real estate property and use the resultant equity pool to invest in income-producing assets that are relatively risky such as stock/equities and real estate. Furthermore, the system 100 can be configured to request for the clients' agreement before acquiring any income-producing asset.

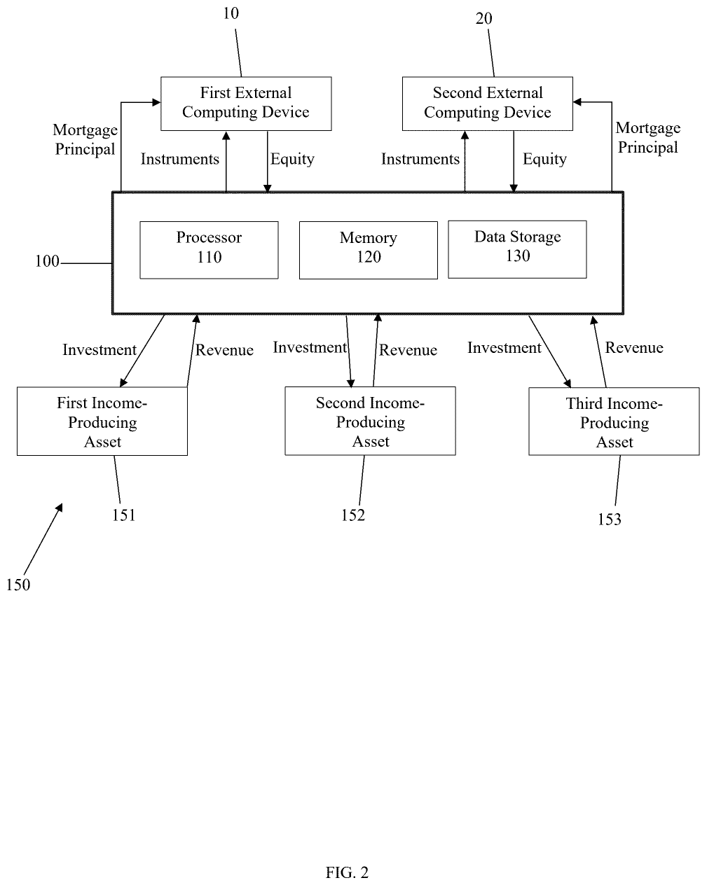

FIG. 2 is a block diagram showing a system 100 for enabling property owners to leverage their home equity for investments in income-producing assets in accordance with some embodiments.

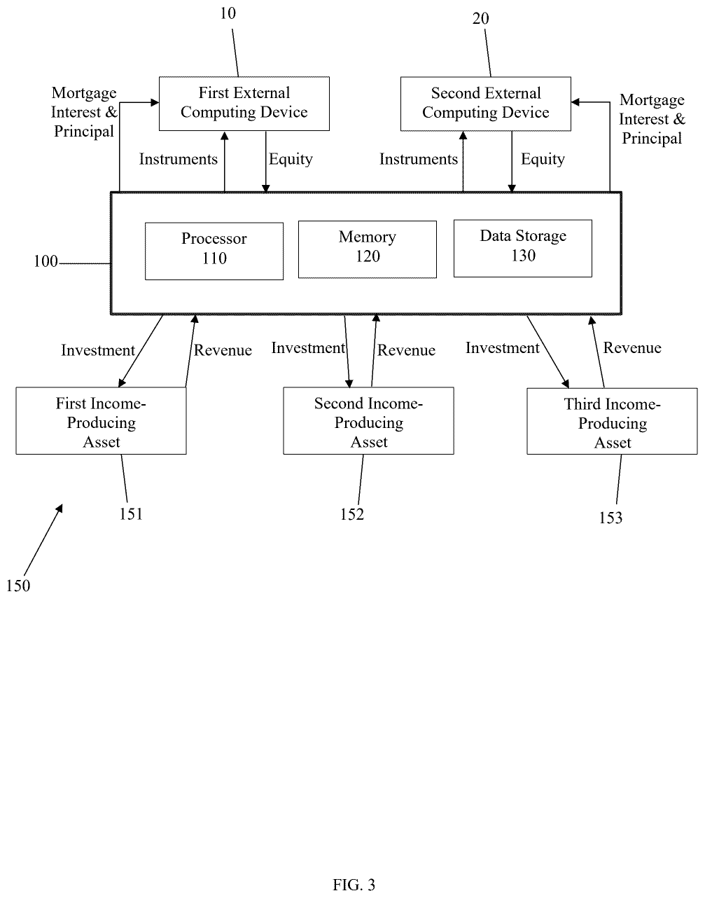

FIG. 3 is a block diagram showing a system 100 for enabling property owners to leverage their home equity for investments in income-producing assets in accordance with some embodiments.

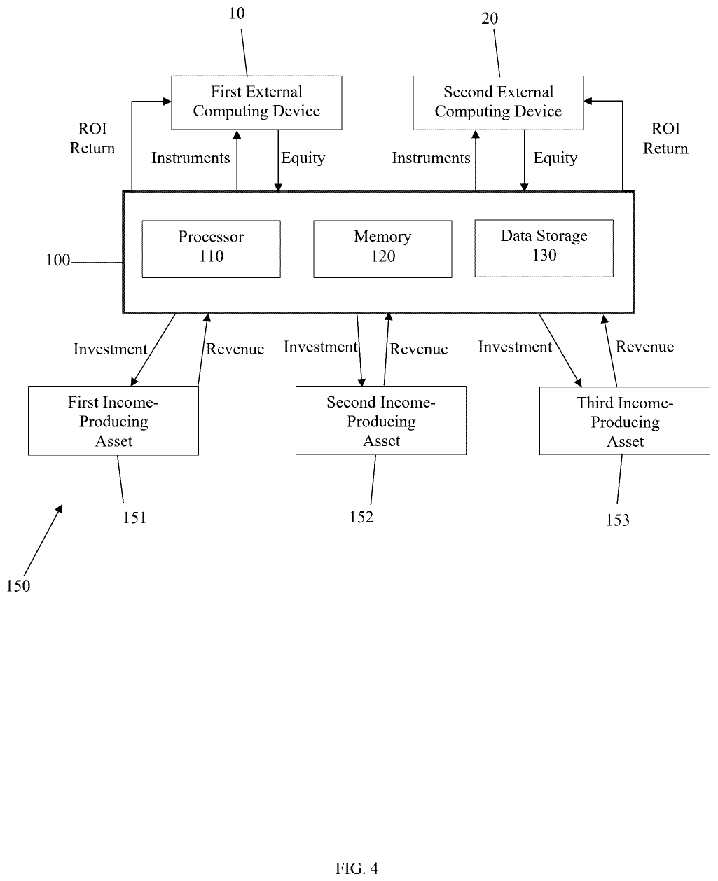

FIG. 4 is a block diagram showing a system 100 for enabling property owners to leverage their home equity for investments in income-producing assets in accordance with some embodiments. In the present embodiment, the system 100 provides the property owner clients with interest with variable rate (preferably ranging from 0%-15%) based on performance of the income-producing assets and client preferences such as investment risk preferences.

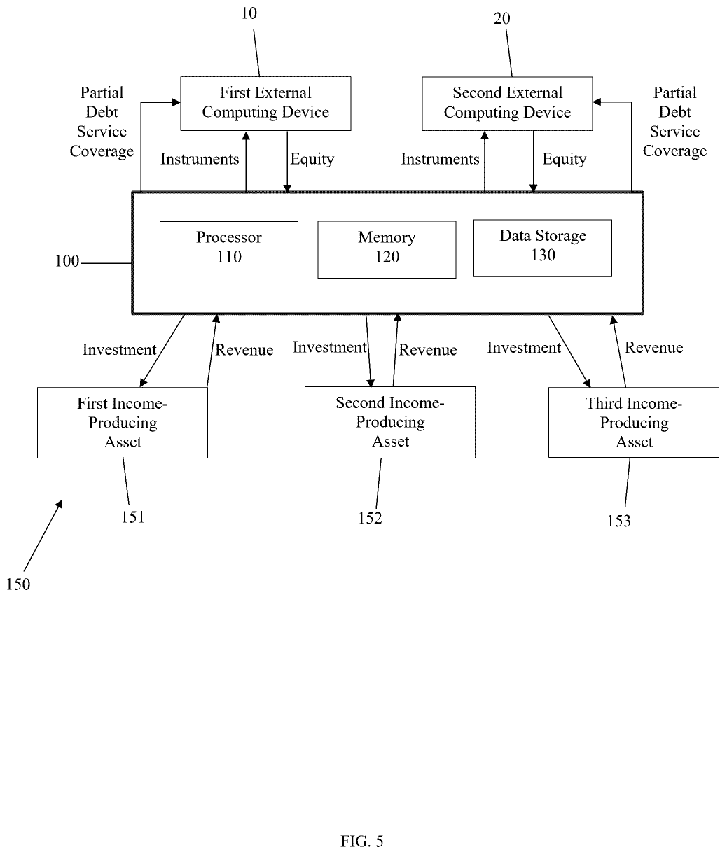

FIG. 5 is a block diagram showing a system 100 for enabling property owners to leverage their home equity for investments in income-producing assets in accordance with some embodiments. FIGS. 2 through 5 illustrate different implementations of the system 100. In particular, FIG. 2 illustrates payment of mortgage principal using revenue from the plurality of income-producing assets 150. FIG. 3 illustrates payment to the first external computing device 10 and/or the second external computing device 20 with partial principal and interest payment coverages. FIG. 4 illustrates payment to the first external computing device 10 and/or the second external computing device 20 with interest with variable rate (preferably ranging from 0%-15%) based on performance of the income-producing assets and client preferences such as investment risk preferences. FIG. 5 illustrates payment to the first external computing device 10 and/or the second external computing device 20 with partial debt service coverage to help the clients to meet the current debt obligations according to the signed contracts.

Further, in some embodiments, the system 100 diversifies investment in order to manage risk and potentially improve returns, by spreading investments across various asset classes, sectors, and geographic regions. The main goal is to reduce the impact of poor performance in any single investment on the overall portfolio to mitigate risk. The processor 110 can use home equity of different groups of clients with different investment preferences to invest in different asset classes, different sections, different regions, and investment vehicles. The asset classes refer to classes having different risk factors such as stocks, bonds, real estate, cash and cash equivalents, and other asset vehicles. The sections refer to field (e.g., technology, healthcare, finance, consumer goods, hospitality and enterprises) with different risk factors, as some field may perform well while others may not. Regions refer to countries or geographic regions with different economic or political situations. Investment vehicles refer to any product used by investors to gain positive returns such as mutual funds, ETF, stocks, and bonds, commodities and futures, either by using traditional methods through investment firms, quantitative investments, hedge funds or proprietary means of investment strategies in the financial markets. By implementing risk management strategies, the system 100 mitigates potential risks associated with leveraging equity, such as property market fluctuations or changes in interest rates. Thus, the system 100 also reduces dependency on any single asset or source of income, thereby enhancing the resilience and sustainability of the overall financial structure.

In addition, as the system 100 make payments under the land contracts or other instruments, they gradually build equity in the properties of the client. The value of the home equity thus increases over time through property appreciation and principal payments, enhancing their financial position and ownership stake in the properties. Subsequently, the first external computing device 10 and/or the second external computing device 20 applies the equity built within the land trusts as leverage to generate additional revenue or financing opportunities. For example, the first external computing device 10 and/or the second external computing device 20 secure loans or lines of credit against the equity in the properties to fund development projects, acquire additional properties, or invest in income-generating assets namely hotels, office and industrial properties, or other industries, hospitality and sectors (same as listed above in other figures).

In another embodiment, the system 100 can also request partnership with insurance providers to offer comprehensive property owners insurance services to all clients as a requirement for mortgage financing. Thus, the system 100 can ensure the first external computing device 10 and/or the second external computing device 20 have access to quality insurance coverage to protect their investment. The processor 110 generates additional revenue through insurance premiums. The system 100 can also be configured to offer rebates from the investment firm providing bonds to back mortgages. These rebates typically amount to 2-3 points for the total loan amount written. This additional source of revenue enhances the profitability of operations and strengthens the financial position of the system 100.

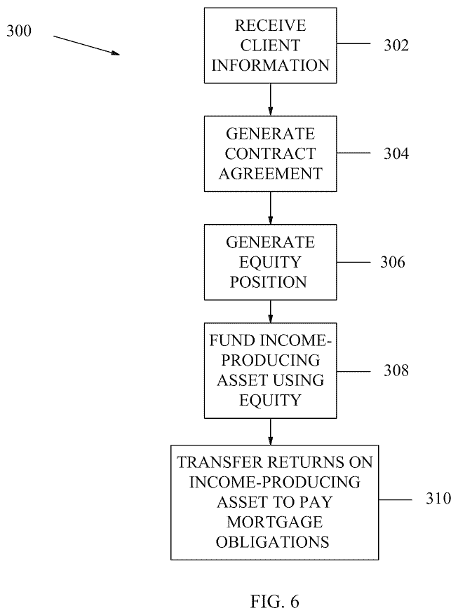

FIG. 6 is a flow diagram illustrating a method 300 for leveraging home equity for investments in an income-producing asset in accordance with some embodiments. The method 300 is described with respect to an example implementation of the system 100 of FIGS. 1 through 5. At block 302, the processor 110 receive selections from the first external computing device 10 and/or the second external computing device 20. The processor 110 retrieves information on the property owner client's agreement from the first external computing device 10 and/or the second external computing device 20. At block 304, the processor 110 generates a contractual agreement based on the information from the first external computing device 10 and/or the second external computing device 20. At block 306, in response to receiving the property owner client's agreement from the first external computing device 10 and/or the second external computing device 20, the processor 110 extracts the home equity (e.g., generates an equity loan) of the first external computing device 10 and/or the second external computing device 20 from the data storage 130. At block 306, the processor 110 transfers the equity to invest in at least one of the plurality of income-producing assets 150. At block 308, the processor 110 uses the revenue generated from the plurality of income-producing assets 150 (acquiring through leveraging the equity on the real estate property of the first external computing device 10 and/or the second external computing device 20) to cover interest payments or ROI on the funds used as collateral.

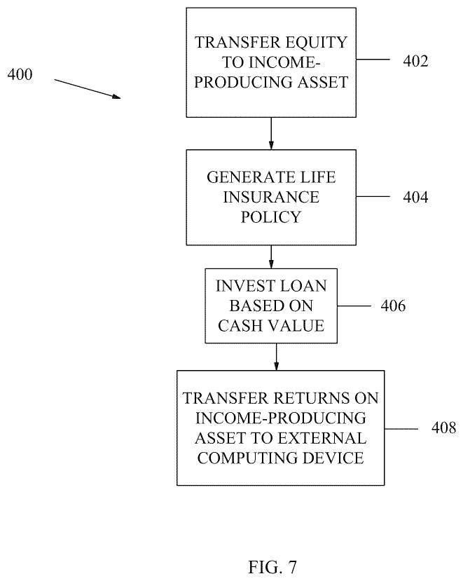

FIG. 7 is a flow diagram illustrating a method 400 for leveraging home equity to generate returns in a life insurance policy in accordance with some embodiments. The method 400 is described with respect to an example implementation of the system 100 of FIGS. 1 through 5. Moreover, the method of FIG. 7 is an example implantation of the system 100 after equity is transferred to at least one of the plurality of income-producing assets 150. At block 402, the processor 110 transfers the equity to invest in at least one of the plurality of income-producing assets 150. At block 404, the processor 110 generates a life insurance policy based on the data and/or information received from the first external computing device 10 and/or the second external computing device 20. At block 406, the processor 110 transfers a portion of the equity as a loan based on a cash value of the life insurance policy to either pay for premiums of the life insurance policy and/or transfer to at least one of the plurality of income-producing assets 150. At block 408, the processor 110 monitors revenue from the at least one of the plurality of income-producing assets 150 and extracts at least a portion of the revenue and sends the funds to the first external computing device 10 and/or the second external computing device 20. In some embodiments, the funds include profit sharing, deferred benefit, and/or surrender value of the life insurance policy.

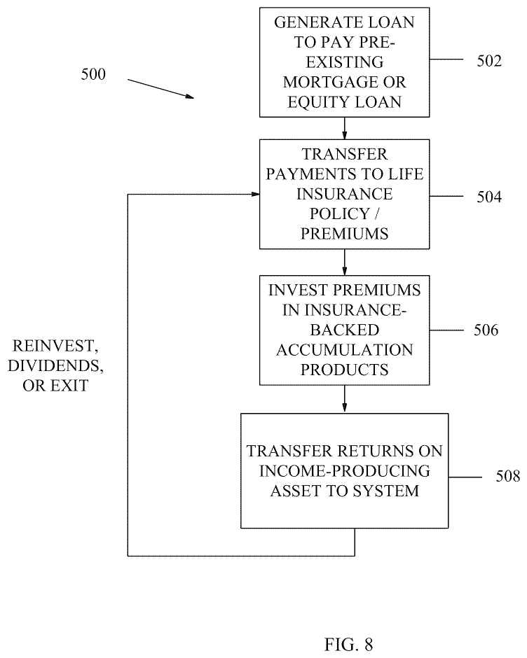

FIG. 8 is a flow diagram illustrating a method 500 for transferring payments for a mortgage to a life insurance policy and generating returns on the life insurance policy in accordance with some embodiments. The method 500 is described with respect to an example implementation of the system 100 of FIGS. 1 through 5. At block 502, the processor 110 generates a loan to at least partially pay and/or payoff a pre-existing mortgage or equity loan. In other words, the processor 110 generates the loan to refinance the mortgage or equity loan. At block 504, the processor 110 transfers at least a portion of the loan to pay life insurance premiums and/or purchase a life insurance policy. At block 506, the processor 110 transfers at least a portion of the payments for the premiums to insurance-backed accumulation products. At block 508, the processor 110 monitors revenue from the at least one of the plurality of income-producing assets 150 and extracts at least a portion of the revenue and sends the funds to the first external computing device 10 and/or the second external computing device 20. In some embodiments, the processor 110 sends the funds that include dividends and/or reinvestment to pay the premiums at block 504.

The list of instruments that can be used by the system 100 to obtain equity position from the property owner client is as follows. Please note that the term “Instrument” of the present disclosure includes both a single legal document and a combination of the legal documents listed below that can be used to tie land trust and land contract together in order to leverage home equity to obtain ownership in income-producing assets and generate revenue.

In one aspect, the present invention is embodied as a system utilizing a comprehensive array of legal and financial instruments to facilitate the conversion of real estate equity into income-producing assets. These instruments, individually or in combination, enable the system to establish beneficial ownership structures, secure collateral positions, and generate revenue streams from the underlying property while transferring premium payments to life insurance policies and investment vehicles. The term “Instrument” of the present disclosure includes both a single legal document and a combination of the legal documents listed below that can be used to tie land trust and land contract together in order to leverage home equity to obtain ownership in income-producing assets and generate revenue.

In one embodiment, the present disclosure is embodied as a system employing traditional real estate financing instruments including: (1) Land Trust, a legal arrangement where a trustee holds title to property for the benefit of a beneficiary, often used for privacy and estate planning; (2) Land Contract (or Contract for Deed), a contract where the seller finances the purchase of real estate, with the buyer making installment payments until the loan is paid off, wherein homeowners may optionally retain an ownership stake or participation right in the underlying insurance contract or capital vehicle, including access to a portion of the accumulated value, performance bonuses, or future surrender proceeds, depending on the contractual structure; (3) Lien Holding Contract, a contract where a lender places a lien on the property as collateral for the loan; (4) Prospectus to Land Holders, a document outlining terms of a real estate investment opportunity; and (5) Equity Sharing Agreement, where lender provides funds in exchange for a share of property's future appreciation or income.

In another embodiment, the disclosure is embodied as a system incorporating: (6) Wraparound Mortgage, where lender assumes seller's mortgage, adds additional loan amount, combining both in single structure; (7) Collateral Assignment of Beneficial Interest, where property owner assigns beneficial interest in land trust as collateral; (8) Participation Loan Agreement, where multiple lenders fund single loan, sharing risks and returns based on participation percentages; (9) Installment Land Contract, where buyer makes installment payments to seller until purchase price is paid off; (10) Equity Mortgage, where lender provides funds based on equity in property; (11) Deed of Trust, where property owner conveys title to trustee as security for loan, trustee has power of sale if borrower defaults; (12) Subordination Agreement, where lender agrees to subordinate lien position to another lender; and (13) Option Agreement, where lender has right (but not obligation) to purchase property at predetermined price within specified period.

In an alternative embodiment, the system utilizes: (14) Reverse Mortgage, for property owners aged 62+ to convert home equity into cash without selling home or new monthly payment; (15) Assignment of Rents and Leases, where property owner assigns right to collect rental income to lender as collateral; (16) Sale and Leaseback Agreement, where property owner sells property to lender, then leases it back; (17) Participation Mortgage, where lender funds part of mortgage in return for part of property's income or appreciation; (18) Mortgage Note, promissory note outlining terms of loan, including interest rate, payment schedule, and terms of repayment; (19) Installment Promissory Note, similar to mortgage note but structured as installment payments; (20) Commercial Mortgage, loan secured by commercial property; (21) Residential Mortgage, loan secured by residential property; (22) Second Mortgage, additional loan on property already mortgaged; (23) Open-End Mortgage, allows borrower to re-borrow up to original loan amount without refinancing; and (24) Closed-End Mortgage, fixed amount loan where borrower cannot re-borrow once paid off.

In a further embodiment, the present invention employs: (25) Balloon Mortgage, short-term mortgage with large final payment (balloon payment) at end; (26) Shared Appreciation Mortgage, where lender receives share of property's appreciation in addition to interest; (27) Graduated Payment Mortgage, where payments start low and increase over time; (28) Home Equity Loan, loan based on equity in home, separate from mortgage; (29) Bridge Loan, short-term loan until permanent financing secured; (30) Construction Loan, loan for construction of new property or significant renovation; (31) Mezzanine Loan, loan secured by ownership interest in entity that owns property; (32) Blanket Mortgage, covers multiple properties under one mortgage; (33) Adjustable Rate Mortgage (ARM), where interest rate adjusts periodically based on financial index; (34) Fixed Rate Mortgage, where interest rate remains constant throughout loan term; (35) Assumable Mortgage, where buyer takes over seller's existing mortgage; (36) Shared Equity Mortgage, where lender shares equity in property's appreciation; (37) Intercreditor Agreement, defines terms between multiple lenders; and (38) Equity Line of Credit (HELOC), revolving credit line secured by home equity.

In yet another embodiment, the system incorporates: (39) Servicing Agreement, where lender services loan for third-party investor; (40) Joint Venture Agreement, partnership for property development or investment; (41) Lease Option, lease with option to buy property at specified price within time frame; (42) Ground Lease, lease of land, tenant may build or improve; (43) Land Banking, purchase and hold undeveloped land as investment; (44) Leasehold Mortgage, loan secured by leasehold interest; (45) Non-Recourse Loan, where lender cannot pursue borrower's assets beyond collateral; (46) Recourse Loan, where lender can pursue borrower's assets beyond collateral; (47) Installment Sale Contract, seller-financed sale with installments; (48) Option to Purchase Agreement, where buyer has option to purchase property at agreed terms; (49) Trust Deed, legal document outlining terms of trust arrangement; (50) Assignment Agreement, transfers rights or property to another party; and (51) Sale Agreement, contract for sale of property.

In an additional embodiment, the disclosure encompasses: (52) Easement Agreement, grants right to use property without ownership; (53) Title Insurance Policy, protects lender against financial loss due to title defects; (54) Survey, land survey to confirm property boundaries; (55) Environmental Assessment, evaluation of environmental impact on property; (56) Title Search, examination of property's title history; (57) Escrow Agreement, holds funds or documents until certain conditions met; (58) Zoning Compliance, ensures property use complies with zoning laws; (59) Municipal Consent, approval from local government for property use; (60) Condominium Declaration, governing document for condominium association; (61) Regulatory Agreement, compliance with government regulations; (62) Permitting, authorization for property development or construction; (63) Prepayment Penalty, fee for paying off loan early; (64) Tax Lien, lien for unpaid taxes; (65) Liability Waiver, release from liability for certain actions; (66) Risk Management Plan, identifies and mitigates property risks; (67) Power of Attorney, legal authority to act on behalf of another party; (68) Construction Agreement, contract for property construction; and (69) Insurance Certificate, proof of property insurance coverage.

In a specialized embodiment, the system utilizes: (70) Construction Draw Agreement, disbursement of funds during construction; (71) Participation Certificate, evidence of ownership in property or project; (72) Quitclaim Deed, transfers property interest without warranties; (73) Right of First Refusal, option to purchase property before others; (74) Title Commitment, insurer's promise to issue title insurance; (75) Hold Harmless Agreement, release from liability for specific actions; (76) Interagency Agreement, agreement between government agencies; (77) Special Warranty Deed, limited warranty of property title; (78) Final Walkthrough, buyer's inspection before property purchase; (79) Property Management Agreement, management services for rental property; (80) Credit Report, borrower's credit history and score; (81) Payment Plan, schedule for loan repayment; (82) Property Appraisal, assessment of property value; (83) Loan Origination Fee, fee for processing loan application; (84) Credit Line, revolving credit for property purchase or improvement; (85) HUD-1 Settlement Statement, itemizes closing costs; (86) Rate Lock Agreement, agreement to lock in interest rate; (87) Earnest Money Agreement, deposit to show buyer's intent; (88) Lease Extension, extends lease agreement period; and (89) Tax Assessment, local government assessment of property value.

In another aspect, the present invention incorporates: (90) Defeasance, discharges debt through bond or escrow account; (91) Interest Rate Cap Agreement, limits interest rate fluctuations; (92) Water Rights Agreement, rights to use water on property; (93) Covenant, legal restriction on property use; (94) Deed Restriction, limits on property use; (95) Right of Way, access to property through another's land; (96) Indemnification Agreement, protects against losses or liabilities; (97) Performance Bond, guarantees contract performance; (98) Asset Purchase Agreement, purchases property or assets; (99) Letter of Intent, agreement for future transaction terms; (100) Contract Negotiation, agreements between parties; (101) Agency Agreement, authorizes agent to act on behalf of principal; (102) Builder's Warranty, guarantees property construction quality; (103) Housing Association Agreement, governs property owner association; (104) Arbitration Agreement, resolves disputes outside of court; (105) Title Transfer, legal transfer of property ownership; (106) Development Agreement, land development obligations; (107) Eminent Domain, government acquisition of private property; (108) Land Lease Agreement, lease of land for development or use; and (109) Plat Map, map showing property boundaries and lots.

In a comprehensive embodiment, the system utilizes: (110) Encroachment Agreement, resolves property line violations; (111) Mortgage Payment, monthly loan payment; (112) Debt Service Coverage Ratio, loan repayment ability; (113) Fair Market Value, property price based on market conditions; (114) Interest-Only Mortgage, payments cover interest only; (115) Hard Money Loan, asset-backed loan with high interest; (116) Pre-Approval Letter, lender's commitment to finance; (117) Tax Deduction, reduces taxable income; (118) Landlord-Tenant Agreement, lease terms for property rental; (119) Property Condition Disclosure, seller's property condition report; (120) Trade Association Membership, industry group affiliation; (121) Proprietary Trading, investment strategy; (122) Special Assessment, charges for property improvements; (123) Right of Survivorship, joint ownership rights; (124) Assignment and Assumption Agreement, property transfer contract; (125) Property Tax, taxes based on property value; (126) Mutual Agreement, shared understanding between parties; (127) Credit Rating, borrower's financial health; (128) Proof of Funds, verification of financial capability; and (129) Listing Agreement, real estate sales contract.

In an innovative embodiment, the disclosure incorporates: (130) Agreement of Purchase and Sale, property sale contract; (131) Counteroffer, modified purchase offer; (132) Multiple Listing Service (MLS), property listing database; (133) Offer to Purchase, buyer's property purchase proposal; (134) Option Contract, right to buy property at set price; (135) Commission Agreement, real estate agent compensation; (136) Land Use Agreement, property development terms; (137) Trust Agreement, fiduciary relationship terms; (138) Credit Application, loan applicant's financial data; (139) Guarantee Agreement, promise to fulfill obligation; (140) Intangible Asset, non-physical property value; (141) Collateral Agreement, loan security terms; (142) Co-Sign Agreement, shared financial responsibility; (143) Market Value, current property price; (144) Concessions, buyer or seller incentives; (145) Market Conditions, real estate environment; (146) Property Disclosure Statement, seller's property condition details; (147) Deed in Lieu of Foreclosure, property transfer to lender; (148) Loan Forgiveness, canceling debt obligation; and (149) Tax Lien Certificate, government lien on property.

In a technology-enhanced embodiment, the system employs: (150) Title Company, real estate transaction intermediary; through (500) Property Separation Services Agreement, property separation services terms; including all intermediate agreements covering collaboration, risk assessment, mutual release, security, insurance, utility, joint ownership, public-private partnership, title opinion, quitclaim deed, incentive, corporate guarantee, private mortgage insurance (PMI), reinstatement, stipulation, investment contract, market adjustment, lease guaranty, payment bond, land use permit, contractual obligation, service contract, land trust agreement, title holding trust, financial instrument, perpetual easement, legal agreement, lease agreement, property improvement agreement, joint venture agreement, resale agreement, ownership agreement, partnership agreement, contractual relationship, sales agreement, real estate contract, economic interest, option agreement, financial arrangement, commercial lease agreement, investment agreement, contractual arrangement, equity agreement, and all related property services agreements.

In a structured products embodiment, the present invention utilizes sophisticated investment vehicles including: Hybrid Index Annuities; Contingent Deferred Annuities (CDAs); Private Placement Life Insurance (PPLI); Deferred Income Annuities (DIAs); Corporate-Owned Life Insurance (COLI); Bank-Owned Life Insurance (BOLI); Collateralized Debt Obligations (CDOs); Collateralized Loan Obligations (CLOs); Tokenized Real Estate Investment Trusts (REITs); Decentralized Finance (DeFi) Lending Pools; Real Estate Token Offerings (RETOs); Pension-Backed Loans; Digital Asset Lending Agreements; Convertible Bond Structures; Hedge Fund Participation Units; Municipal Bond Ladders; Structured Treasury Note Instruments; Synthetic Equity Swaps; Royalty-Based Investment Agreements; Blockchain Escrow Agreements; Qualified Opportunity Fund Agreements; Credit Default Swaps; Sovereign Debt Participation Contracts; Shared Appreciation Agreements; Portfolio Margin Loans; On-Chain Collateral Vaults; Enterprise Revenue Sharing Agreements; Family Banking Trusts; Cash Balance Pension Plans; Business Development Company (BDC) Structures; Indexed Savings Certificates; Private Collateral Pools; Actuarially Managed Trusts; Trust-Owned Contracts with Embedded Riders; Universal Life Policies with Executive Bonus Plans; Strategic Partner Equity Agreements; Synthetic Real Estate Derivatives; Funded Reinsurance Structures; Capital Lease Financing; Private Credit Facility Agreements; NFT-Backed Loan Contracts; Venture Capital Participation Notes; Accelerated Benefit Riders (ABRs); Retained Death Benefit Agreements; Microfinance Participation Loans; Forward Commitment Contracts; Alternative Liquidity Agreements (ALAs); Multi-Class Equity Waterfall Agreements; Digital Token Vault Agreements; Blockchain Smart Contract Escrows; InsurTech-Managed Wealth Pods; Indexed CD Products with Put/Call Features; Securities-Based Lines of Credit (SBLOCs); Income Share Agreements (ISAs); Chartered Lending Trusts; Project Finance Waterfall Agreements; Business Continuation Buy/Sell Agreements; High-Yield Bond Laddering Structures; Private Insurance Captive Structures; Guaranteed Issue Term Conversion Contracts; Intellectual Property-Backed Lending Instruments; Charitable Lead Trusts (CLTs); Charitable Remainder Trusts (CRTs); Tax Allocation Swap Agreements; Real Asset Participation Trusts; Equity Collar Strategies; Zero-Coupon Life Settlement Vehicles; Synthetic Life Insurance Pools; Proprietary Index Allocation Contracts; Customized Glidepath Investment Agreements; Portfolio Risk-Bucketing Agreements; Corporate Split-Dollar Agreements; Interest Rate Swap Agreements; Value-Sharing Family Office Contracts; Viatical Settlement Vehicles; Private Equity Note Participation Contracts; Deferred Distribution Agreements; Alternative Investment Trust Deeds; Self-Directed IRA Trust Agreements; Endowment-Based Lending Pools; Healthcare Savings Hedge Agreements; Volatility-Controlled Structured Products; Long-Duration Reinsurance Participations; Policy-Based Line of Credit Agreements; Credit Enhancement Bonds; Off-Balance Sheet Leaseback Trusts; Income-Indexed Tontine Structures; Capital Recovery Bonds; Maturity-Agnostic Escrow Trusts; Synthetic Bank Participation Loans; AI-Managed Investment Accounts; Income Acceleration Sidecars; Tokenized Annuity Pools; Smart Index Algorithmic Trusts; Stochastic Risk Pooling Contracts; Hybrid Retirement Income Bridges; Deferred Surrender Bonus Pools; Insurance-Linked Securities (ILS); Mortgage-Payoff Indexed Units; and Mortgage Conversion Participation Pools.

The comprehensive list of instruments provides the system with maximum flexibility to structure transactions according to specific client needs, regulatory requirements, and market conditions while achieving the fundamental objective of converting real estate equity into life insurance premiums and investment returns through income-producing assets.

The list below is a sample list of instruments that can be used to achieve the goals of this system, and includes:

1. **Land Trust**: A legal arrangement where a trustee holds title to property for the benefit of a beneficiary, often used for privacy and estate planning.

2. **Land Contract (or Contract for Deed)**: A contract where the seller finances the purchase of real estate, with the buyer making installment payments until the loan is paid off. Homeowners may optionally retain an ownership stake or participation right in the underlying insurance contract or capital vehicle, including access to a portion of the accumulated value, performance bonuses, or future surrender proceeds, depending on the contractual structure.

3. **Lien Holding Contract**: A contract where a lender places a lien on the property as collateral for the loan, all4. **Prospectus to Land Holders**: A document outlining terms of a real estate investment opportunity, attraction.

5. **Equity Sharing Agreement**: Lender provides funds in exchange for a share of property's future appreciation or income.

6. **Wraparound Mortgage**: Lender assumes seller's mortgage, adds additional loan amount, combining both in

7. **Collateral Assignment of Beneficial Interest**: Property owner assigns beneficial interest in land trust as collateral.

8. **Participation Loan Agreement**: Multiple lenders fund single loan, sharing risks and returns based on participation percentages.

9. **Installment Land Contract**: Buyer makes installment payments to seller until purchase price is paid off.

10. **Equity Mortgage**: Lender provides funds based on equity in property.

11. **Deed of Trust**: Property owner conveys title to trustee as security for loan, trustee has power of sale if borrow defaults.

12. **Subordination Agreement**: Lender agrees to subordinate lien position to another lender.

13. **Option Agreement**: Lender has right (but not obligation) to purchase property at predetermined price within specified period.

14. **Reverse Mortgage**: Property owners aged 62+ convert home equity into cash without selling home or new monthly payment.

15. **Assignment of Rents and Leases**: Property owner assigns right to collect rental income to lender as collateral

16. **Sale and Leaseback Agreement**: Property owner sells property to lender, then leases it back.

17. **Participation Mortgage**: Lender funds part of mortgage in return for part of property's income or appreciation.

18. **Mortgage Note**: Promissory note outlining terms of loan, including interest rate, payment schedule, and terms of repayment.

19. **Installment Promissory Note**: Similar to mortgage note but structured as installment payments.

20. **Commercial Mortgage**: Loan secured by commercial property.

21. **Residential Mortgage**: Loan secured by residential property.

22. **Second Mortgage**: Additional loan on property already mortgaged.

23. **Open-End Mortgage**: Allows borrower to re-borrow up to original loan amount without refinancing.

24. **Closed-End Mortgage**: Fixed amount loan where borrower cannot re-borrow once paid off.

25. **Balloon Mortgage**: Short-term mortgage with large final payment (balloon payment) at end.

26. **Shared Appreciation Mortgage**: Lender receives share of property's appreciation in addition to interest.27. **Graduated Payment Mortgage**: Payments start low and increase over time.

28. **Home Equity Loan**: Loan based on equity in home, separate from mortgage.

29. **Bridge Loan**: Short-term loan until permanent financing secured.

30. **Construction Loan**: Loan for construction of new property or significant renovation.

31. **Mezzanine Loan**: Loan secured by ownership interest in entity that owns property.

32. **Blanket Mortgage**: Covers multiple properties under one mortgage.

33. **Adjustable Rate Mortgage (ARM)**: Interest rate adjusts periodically based on financial index.

34. **Fixed Rate Mortgage**: Interest rate remains constant throughout loan term.

35. **Assumable Mortgage**: Buyer takes over seller's existing mortgage.

36. **Shared Equity Mortgage**: Lender shares equity in property's appreciation.

37. **Intercreditor Agreement**: Defines terms between multiple lenders.

38. **Equity Line of Credit (HELOC)**: Revolving credit line secured by home equity.

39. **Servicing Agreement**: Lender services loan for third-party investor.

40. **Joint Venture Agreement**: Partnership for property development or investment.

41. **Lease Option**: Lease with option to buy property at specified price within time frame.

42. **Ground Lease**: Lease of land, tenant may build or improve.

43. **Land Banking**: Purchase and hold undeveloped land as investment.

44. **Leasehold Mortgage**: Loan secured by leasehold interest.

45. **Non-Recourse Loan**: Lender cannot pursue borrower's assets beyond collateral.

46. **Recourse Loan**: Lender can pursue borrower's assets beyond collateral.

47. **Installment Sale Contract**: Seller-financed sale with installments.

48. **Option to Purchase Agreement**: Buyer has option to purchase property at agreed terms.

49. **Trust Deed**: Legal document outlining terms of trust arrangement.

50. **Assignment Agreement**: Transfers rights or property to another party.51. **Sale Agreement**: Contract for sale of property.

52. **Easement Agreement**: Grants right to use property without ownership.

53. **Title Insurance Policy**: Protects lender against financial loss due to title defects.

54. **Survey**: Land survey to confirm property boundaries.

55. **Environmental Assessment**: Evaluation of environmental impact on property.

56. **Title Search**: Examination of property's title history.

57. **Escrow Agreement**: Holds funds or documents until certain conditions met.

58. **Zoning Compliance**: Ensures property use complies with zoning laws.

59. **Municipal Consent**: Approval from local government for property use.

60. **Condominium Declaration**: Governing document for condominium association.

61. **Regulatory Agreement**: Compliance with government regulations.

62. **Permitting**: Authorization for property development or construction.

63. **Prepayment Penalty**: Fee for paying off loan early.

64. **Tax Lien**: Lien for unpaid taxes.

65. **Liability Waiver**: Release from liability for certain actions.

66. **Risk Management Plan**: Identifies and mitigates property risks.

67. **Power of Attorney**: Legal authority to act on behalf of another party.

68. **Construction Agreement**: Contract for property construction.

69. **Insurance Certificate**: Proof of property insurance coverage.

70. **Construction Draw Agreement**: Disbursement of funds during construction.

71. **Participation Certificate**: Evidence of ownership in property or project.

72. **Quitclaim Deed**: Transfers property interest without warranties.

73. **Right of First Refusal**: Option to purchase property before others. 74. **Title Commitment**: Insurer's promise to issue title insurance.

75. **Hold Harmless Agreement**: Release from liability for specific actions.

76. **Interagency Agreement**: Agreement between government agencies.

77. **Special Warranty Deed**: Limited warranty of property title.

78. **Final Walkthrough**: Buyer's inspection before property purchase.

79. **Property Management Agreement**: Management services for rental property.

80. **Credit Report**: Borrower's credit history and score.

81. **Payment Plan**: Schedule for loan repayment.

82. **Property Appraisal**: Assessment of property value.

83. **Loan Origination Fee**: Fee for processing loan application.

84. **Credit Line**: Revolving credit for property purchase or improvement.

85. **HUD-1 Settlement Statement**: Itemizes closing costs.

86. **Rate Lock Agreement**: Agreement to lock in interest rate.

87. **Earnest Money Agreement**: Deposit to show buyer's intent.

88. **Lease Extension**: Extends lease agreement period.

89. **Tax Assessment**: Local government assessment of property value.

90. **Defeasance**: Discharges debt through bond or escrow account.

91. **Interest Rate Cap Agreement**: Limits interest rate fluctuations.

92. **Water Rights Agreement**: Rights to use water on property.

93. **Covenant**: Legal restriction on property use.

94. **Deed Restriction**: Limits on property use.

95. **Right of Way**: Access to property through another's land.

96. **Indemnification Agreement**: Protects against losses or liabilities.

97. **Performance Bond**: Guarantees contract performance.98. **Asset Purchase Agreement**: Purchases property or assets.

99. **Letter of Intent**: Agreement for future transaction terms.

100. **Contract Negotiation**: Agreements between parties.

101. **Agency Agreement**: Authorizes agent to act on behalf of principal.

102. **Builder's Warranty**: Guarantees property construction quality.

103. **Housing Association Agreement**: Governs property owner association.

104. **Arbitration Agreement**: Resolves disputes outside of court.

105. **Title Transfer**: Legal transfer of property ownership.

106. **Development Agreement**: Land development obligations.

107. **Eminent Domain**: Government acquisition of private property.

108. **Land Lease Agreement**: Lease of land for development or use.

109. **Plat Map**: Map showing property boundaries and lots.

110. **Encroachment Agreement**: Resolves property line violations.

111. **Mortgage Payment**: Monthly loan payment.

112. **Debt Service Coverage Ratio**: Loan repayment ability.

113. **Fair Market Value**: Property price based on market conditions.

114. **Interest-Only Mortgage**: Payments cover interest only.

115. **Hard Money Loan**: Asset-backed loan with high interest.

116. **Pre-Approval Letter**: Lender's commitment to finance.

117. **Tax Deduction**: Reduces taxable income.

118. **Landlord-Tenant Agreement**: Lease terms for property rental.

119. **Property Condition Disclosure**: Seller's property condition report.

120. **Trade Association Membership**: Industry group affiliation. 121.

**Proprietary Trading**: Investment strategy.

122. **Special Assessment**: Charges for property improvements.

123. **Right of Survivorship**:

Joint ownership rights.

124. **Assignment and Assumption Agreement**: Property transfer contract.

125. **Property Tax**: Taxes based on property value.

126. **Mutual Agreement**: Shared understanding between parties.

127. **Credit Rating**: Borrower's financial health.

128. **Proof of Funds**: Verification of financial capability.

129. **Listing Agreement**: Real estate sales contract.

130. **Agreement of Purchase and Sale**: Property sale contract.

131. **Counteroffer**: Modified purchase offer.

132. **Multiple Listing Service (MLS)**: Property listing database.

133. **Offer to Purchase**: Buyer's property purchase proposal.

134. **Option Contract**: Right to buy property at set price.

135. **Commission Agreement**: Real estate agent compensation.

136. **Land Use Agreement**: Property development terms.

137. **Trust Agreement**: Fiduciary relationship terms.

138. **Credit Application**: Loan applicant's financial data.

139. **Guarantee Agreement**: Promise to fulfill obligation.

140. **Intangible Asset**: Non-physical property value.

141. **Collateral Agreement**: Loan security terms.

142. **Co-Sign Agreement**: Shared financial responsibility.

143. **Market Value**: Current property price.144. **Concessions**: Buyer or seller incentives.

145. **Market Conditions**: Real estate environment.

146. **Property Disclosure Statement**: Seller's property condition details.

147. **Deed in Lieu of Foreclosure**: Property transfer to lender.

148. **Loan Forgiveness**: Canceling debt obligation.

149. **Tax Lien Certificate**: Government lien on property.

150. **Title Company**: Real estate transaction intermediary.

151. **Collaboration Agreement**: Joint venture terms.

152. **Risk Assessment**: Property investment evaluation.

153. **Mutual Release Agreement**: Discharge of obligations.

154. **Security Agreement**: Loan collateral terms.

155. **Insurance Agreement**: Property coverage terms.

156. **Tax Agreement**: Property tax payment plan.

157. **Utility Agreement**: Service provider terms.

158. **Joint Ownership Agreement**: Property co-ownership terms.

159. **Public-Private Partnership**: Government and private sector collaboration.

160. **Title Opinion**: Legal property ownership assessment.

161. **Quitclaim Deed**: Property interest transfer.

162. **Incentive Agreement**: Encourages property investment.

163. **Corporate Guarantee**: Business entity assurance.

164. **Private Mortgage Insurance (PMI)**: Lender protection.

165. **Reinstatement Agreement**: Loan payment plan.

166. **Stipulation Agreement**: Conditions agreement. 167. **Investment Contract**: Property investment terms.

168. **Market Adjustment**: Property value correction.

169. **Lease Guaranty**: Lease security assurance.

170. **Payment Bond**: Construction payment assurance.

171. **Land Use Permit**: Property development approval.

172. **Contractual Obligation**: Property transaction agreement.

173. **Service Contract**: Property service agreement.

174. **Land Trust Agreement**: Property title protection.

175. **Title Holding Trust**: Property title retention.

176. **Financial Instrument**: Property financing tool.

177. **Perpetual Easement**: Property use right.

178. **Legal Agreement**: Property transaction terms.

179. **Lease Agreement**: Property rental terms.

180. **Property Improvement Agreement**: Development terms.

181. **Joint Venture Agreement**: Property investment terms.

182. **Resale Agreement**: Property re-sale terms.

183. **Ownership Agreement**: Property ownership terms.

184. **Partnership Agreement**: Property partnership terms.

185. **Contractual Relationship**: Property transaction terms.

186. **Sales Agreement**: Property sales terms.

187. **Real Estate Contract**: Property transaction terms.

188. **Economic Interest**: Property financial stake.

189. **Option Agreement**: Property purchase terms.

190. **Financial Arrangement**: Property transaction terms. 191. **Commercial Lease Agreement**: Property rental terms.

192. **Investment Agreement**: Property investment terms.

193. **Contractual Arrangement**: Property transaction terms.

194. **Equity Agreement**: Property ownership terms.

195. **Financial Arrangement**: Property transaction terms.

196. **Commercial Real Estate Lease Agreement**: Property rental terms.

197. **Development Agreement**: Property development terms.

198. **Commercial Property Lease Agreement**: Property rental terms.

199. **Acquisition Agreement**: Property purchase terms.

200. **Tenant Lease Agreement**: Property rental terms.

201. **Lease Option Agreement**: Property lease terms.

202. **Commercial Real Estate Contract**: Property transaction terms.

203. **Financial Security**: Property transaction assurance.

204. **Leasehold Agreement**: Property lease terms.

205. **Investment Property Agreement**: Property investment terms.

206. **Equitable Agreement**: Property transaction fairness.

207. **Financial Lending Agreement**: Property financing terms.

208. **Equity Interest Agreement**: Property ownership terms.

209. **Lease Purchase Agreement**: Property rental terms.

210. **Equitable Trust Agreement**: Property trust terms.

211. **Joint Ownership Interest**: Property ownership terms.

212. **Real Property Agreement**: Property transaction terms.

213. **Lender Agreement**: Property financing terms.214. **Loan Transaction**: Property financing terms.

215. **Subordination Agreement**: Property lien terms.

216. **Agreement of Sale**: Property purchase terms.

217. **Financing Agreement**: Property financing terms.

218. **Legal Rights**: Property ownership terms.

219. **Acquisition Contract**: Property purchase terms.

220. **Investment Property Lease Agreement**: Property lease terms.

221. **Property Use Agreement**: Property utilization terms.

222. **Property Transfer Agreement**: Property transaction terms.

223. **Right of Entry Agreement**: Property access terms.

224. **Contractual Rights**: Property transaction terms.

225. **Legal Obligations**: Property transaction terms.

226. **Promissory Note**: Loan repayment terms.

227. **Investment Property Lease Agreement**: Property lease terms.

228. **Property Redemption Agreement**: Property transfer terms.

229. **Trust Deed**: Property trust terms.

230. **Repayment Agreement**: Loan repayment terms.

231. **Real Estate Trust Agreement**: Property trust terms.

232. **Tax-Deferred Exchange Agreement**: Property exchange terms.

233. **Property Registration Agreement**: Property registration terms.

234. **Property Indemnity Agreement**: Property transaction terms.

235. **Property Mortgage Agreement**: Property mortgage terms.

236. **Property Resale Agreement**: Property resale terms.

237. **Property Title Agreement**: Property title terms.238. **Property Warranty Agreement**: Property warranty terms.

239. **Property Collateral Agreement**: Property collateral terms.

240. **Property Rental Agreement**: Property rental terms.

241. **Property Endorsement Agreement**: Property endorsement terms.

242. **Property Security Agreement**: Property security terms.

243. **Property Partnership Agreement**: Property partnership terms.

244. **Property Security Interest**: Property security terms.

245. **Property Holding Agreement**: Property holding terms.

246. **Property Prepayment Agreement**: Property prepayment terms.

247. **Property Finance Agreement**: Property finance terms.

248. **Property Obligations**: Property transaction terms.

249. **Property Construction Agreement**: Property construction terms.

250. **Property Loan Agreement**: Property loan terms.

251. **Property Execution Agreement**: Property execution terms.

252. **Property Revenue Agreement**: Property revenue terms.

253. **Property Acquisition Agreement**: Property acquisition terms.

254. **Property Services Agreement**: Property service terms.

255. **Property Lease Agreement**: Property lease terms.

256. **Property Regulation Agreement**: Property regulation terms.

257. **Property Entitlement Agreement**: Property entitlement terms.

258. **Property Servicing Agreement**: Property servicing terms.

259. **Property Closure Agreement**: Property closure terms.

260. **Property Debt Agreement**: Property debt terms.261. **Property Valuation Agreement**: Property valuation terms.

262. **Property Establishment Agreement**: Property establishment terms.

263. **Property Lease Option Agreement**: Property lease option terms.

264. **Property Exemption Agreement**: Property exemption terms.

265. **Property Income Agreement**: Property income terms.

266. **Property Authority Agreement**: Property authority terms.

267. **Property Title Assignment Agreement**: Property title assignment terms.

268. **Property Disposition Agreement**: Property disposition terms.

269. **Property Payment Agreement**: Property payment terms.

270. **Property Performance Agreement**: Property performance terms.

271. **Property Assignment Agreement**: Property assignment terms.

272. **Property Indenture Agreement**: Property indenture terms.

273. **Property Classification Agreement**: Property classification terms.

274. **Property Encumbrance Agreement**: Property encumbrance terms.

275. **Property Access Agreement**: Property access terms.

276. **Property Lease Purchase Agreement**: Property lease purchase terms.

277. **Property Rental Income Agreement**: Property rental income terms.

278. **Property Tax Agreement**: Property tax terms.

279. **Property Insurance Agreement**: Property insurance terms.

280. **Property Holding Trust Agreement**: Property holding trust terms.

281. **Property Custody Agreement**: Property custody terms.

282. **Property Management Agreement**: Property management terms.

283. **Property Leasehold Agreement**: Property leasehold terms.

284. **Property Development Agreement**: Property development terms.285. **Property Rescheduling Agreement**: Property rescheduling terms.

286. **Property Trustee Agreement**: Property trustee terms.

287. **Property Acquisition and Development Agreement**: Property acquisition and development terms.

288. **Property Exchange Agreement**: Property exchange terms.

289. **Property Interests Agreement**: Property interests terms.

290. **Property Deed of Trust Agreement**: Property deed of trust terms.

291. **Property Discharge Agreement**: Property discharge terms.

292. **Property Debt Service Agreement**: Property debt service terms.

293. **Property Realization Agreement**: Property realization terms.

294. **Property Charge Agreement**: Property charge terms.

295. **Property Acknowledgment Agreement**: Property acknowledgment terms.

296. **Property Disposal Agreement**: Property disposal terms.

297. **Property Acquisition Finance Agreement**: Property acquisition finance terms.

298. **Property Land Lease Agreement

**: Property land lease terms.

299. **Property and Management Agreement**: Property and management terms.

300. **Property Assignment of Deed of Trust Agreement**: Property assignment of deed of trust terms.

301. **Property Investment Management Agreement**: Property investment management terms.

302. **Property Delivery Agreement**: Property delivery terms.

303. **Property Borrowing Agreement**: Property borrowing terms.

304. **Property Service Agreement**: Property service terms.

305. **Property Tenancy Agreement**: Property tenancy terms.

306. **Property Set-Off Agreement**: Property set-off terms.307. **Property Agreement of Sale**: Property agreement of sale terms.

308. **Property Exchange Contract**: Property exchange terms.

309. **Property Collaboration Agreement**: Property collaboration terms.

310. **Property Joint Ownership Agreement**: Property joint ownership terms.

311. **Property Settlement Agreement**: Property settlement terms.

312. **Property Mortgage Deed Agreement**: Property mortgage deed terms.

313. **Property Special Warranty Deed Agreement**: Property special warranty deed terms.

314. **Property Contract Agreement**: Property contract terms.

315. **Property Offer to Purchase Agreement**: Property offer to purchase terms.

316. **Property Title Deed Agreement**: Property title deed terms.

317. **Property Buy-Sell Agreement**: Property buy-sell terms.

318. **Property Insolvency Agreement**: Property insolvency terms.

319. **Property Bankruptcy Agreement**: Property bankruptcy terms.

320. **Property Receivership Agreement**: Property receivership terms.

321. **Property Investment Agreement**: Property investment terms.

322. **Property Payment Plan Agreement**: Property payment plan terms.

323. **Property Leaseback Agreement**: Property leaseback terms.

324. **Property Partition Agreement**: Property partition terms.

325. **Property Divestiture Agreement**: Property divestiture terms.

326. **Property Receivable Agreement**: Property receivable terms.

327. **Property Authorization Agreement**: Property authorization terms.

328. **Property Control Agreement**: Property control terms.

329. **Property Exit Agreement**: Property exit terms.

330. **Property Trade Agreement**: Property trade terms.331. **Property Enforcement Agreement**: Property enforcement terms.

332. **Property Cost Sharing Agreement**: Property cost sharing terms.

333. **Property Lease Extension Agreement**: Property lease extension terms.

334. **Property Mediation Agreement**: Property mediation terms.

335. **Property Trading Agreement**: Property trading terms.

336. **Property Tax Sharing Agreement**: Property tax sharing terms.

337. **Property Grant Agreement**: Property grant terms.

338. **Property Allocation Agreement**: Property allocation terms.

339. **Property Risk Management Agreement**: Property risk management terms.

340. **Property Withdrawal Agreement**: Property withdrawal terms.

341. **Property Donation Agreement**: Property donation terms.

342. **Property Insurance Coverage Agreement**: Property insurance coverage terms.

343. **Property Warranty Deed Agreement**: Property warranty deed terms.

344. **Property Swap Agreement**: Property swap terms.

345. **Property Capitalization Agreement**: Property capitalization terms.

346. **Property Beneficiary Agreement**: Property beneficiary terms.

347. **Property Title Transfer Agreement**: Property title transfer terms.

348. **Property Financing Agreement**: Property financing terms.

349. **Property Distribution Agreement**: Property distribution terms.

350. **Property Deed of Assignment Agreement**: Property deed of assignment terms.

351. **Property Payment Agreement**: Property payment terms.

352. **Property Support Agreement**: Property support terms.

353. **Property Separation Agreement**: Property separation terms.354. **Property Assurance Agreement**: Property assurance terms.

355. **Property Partnership Agreement**: Property partnership terms.

356. **Property Indemnification Agreement**: Property indemnification terms.

357. **Property Operation Agreement**: Property operation terms.

358. **Property Documentation Agreement**: Property documentation terms.

359. **Property Maturity Agreement**: Property maturity terms.

360. **Property Possession Agreement**: Property possession terms.

361. **Property Licensing Agreement**: Property licensing terms.

362. **Property Reconstruction Agreement**: Property reconstruction terms.

363. **Property Repayment Agreement**: Property repayment terms.

364. **Property Cancellation Agreement**: Property cancellation terms.

365. **Property Acceptance Agreement**: Property acceptance terms.

366. **Property Extension Agreement**: Property extension terms.

367. **Property Distribution of Profits Agreement**: Property distribution of profits terms.

368. **Property Investment Holding Agreement**: Property investment holding terms.

369. **Property Tax Settlement Agreement**: Property tax settlement terms.

370. **Property Conveyance Agreement**: Property conveyance terms.

371. **Property Incentive Agreement**: Property incentive terms.

372. **Property Mortgage Release Agreement**: Property mortgage release terms.

373. **Property Registering Agreement**: Property registering terms.

374. **Property Trade Assignment Agreement**: Property trade assignment terms.

375. **Property Disposal Declaration Agreement**: Property disposal declaration terms.

376. **Property Down Payment Agreement**: Property down payment terms.

377. **Property Bidding Agreement**: Property bidding terms.378. **Property Option Payment Agreement**: Property option payment terms.

379. **Property Term Agreement**: Property term terms.

380. **Property Measurement Agreement**: Property measurement terms.

381. **Property Executive Committee Agreement**: Property executive committee terms.

382. **Property Development Agreement**: Property development terms.

383. **Property Dissolution Agreement**: Property dissolution terms.

384. **Property Book Agreement**: Property book terms.

385. **Property Imbalance Agreement**: Property imbalance terms.

386. **Property Contribution Agreement**: Property contribution terms.

387. **Property Apportionment Agreement**: Property apportionment terms.

388. **Property Lease Surrender Agreement**: Property lease surrender terms.

389. **Property Repossession Agreement**: Property repossession terms.

390. **Property Occupancy Agreement**: Property occupancy terms.

391. **Property Concession Agreement**: Property concession terms.

392. **Property Title Distribution Agreement**: Property title distribution terms.

393. **Property Association Agreement**: Property association terms.

394. **Property Value Agreement**: Property value terms.

395. **Property Fairness Agreement**: Property fairness terms.

396. **Property License Agreement**: Property license terms.

397. **Property Booklet Agreement**: Property booklet terms.

398. **Property Lease Endorsement Agreement**: Property lease endorsement terms.

399. **Property Compromise Agreement**: Property compromise terms.

400. **Property Settlement Trust Agreement**: Property settlement trust terms.401. **Property Grant Deed Agreement**: Property grant deed terms.

402. **Property Verification Agreement**: Property verification terms.

403. **Property Unilateral Agreement**: Property unilateral terms.

404. **Property Encumbrance Agreement**: Property encumbrance terms.

405. **Property Enfranchisement Agreement**: Property enfranchisement terms.

406. **Property Certainty Agreement**: Property certainty terms.

407. **Property Reorganization Agreement**: Property reorganization terms.

408. **Property Grantor Agreement**: Property grantor terms.

409. **Property Violation Agreement**: Property violation terms.

410. **Property Agent Agreement**: Property agent terms.

411. **Property Warranty Agreement**: Property warranty terms.

412. **Property Holders Agreement**: Property holders terms.

413. **Property Accession Agreement**: Property accession terms.

414. **Property Distribution Services Agreement**: Property distribution services terms.

415. **Property Registration Services Agreement**: Property registration services terms.

416. **Property Tax Services Agreement**: Property tax services terms.

417. **Property Stamp Duty Agreement**: Property stamp duty terms.

418. **Property Restoration Services Agreement**: Property restoration services terms.

419. **Property Lease Services Agreement**: Property lease services terms.

420. **Property Lease Purchase Services Agreement**: Property lease purchase services terms.

421. **Property Purchase Services Agreement**: Property purchase services terms.

422. **Property Income Services Agreement**: Property income services terms.

423. **Property Rent Services Agreement**: Property rent services terms.

424. **Property Realization Services Agreement**: Property realization services terms.425. **Property Transaction Services Agreement**: Property transaction services terms.

426. **Property Acquisition Services Agreement**: Property acquisition services terms.

427. **Property Execution Services Agreement**: Property execution services terms.

428. **Property Divestiture Services Agreement**: Property divestiture services terms.

429. **Property Transfer Services Agreement**: Property transfer services terms.

430. **Property Withdrawal Services Agreement**: Property withdrawal services terms.

431. **Property Refinance Services Agreement**: Property refinance services terms.

432. **Property Purchase and Sale Services Agreement**: Property purchase and sale services terms.

433. **Property Appraisal Services Agreement**: Property appraisal services terms.

434. **Property Assessment Services Agreement**: Property assessment services terms.

435. **Property Valuation Services Agreement**: Property valuation services terms.

436. **Property Financing Services Agreement**: Property financing services terms.

437. **Property Capitalization Services Agreement**: Property capitalization services terms.

438. **Property Insurance Services Agreement**: Property insurance services terms.

439. **Property Tax Services Agreement**: Property tax services terms.

440. **Property Trust Services Agreement**: Property trust services terms.

441. **Property Indemnity Services Agreement**: Property indemnity services terms.

442. **Property Registration Services Agreement**: Property registration services terms.

443. **Property Collateral Services Agreement**: Property collateral services terms.

444. **Property Management Services Agreement**: Property management services terms.

445. **Property Leasehold Services Agreement**: Property leasehold services terms.

446. **Property Development Services Agreement**: Property development services

terms.

447. **Property Rescheduling Services Agreement**: Property rescheduling services terms.448. **Property Liquidation Services Agreement**: Property liquidation services terms.

449. **Property Receivership Services Agreement**: Property receivership services terms.

450. **Property Distribution Services Agreement**: Property distribution services terms.

451. **Property Financing Services Agreement**: Property financing services terms.

452. **Property Partition Services Agreement**: Property partition services terms.

453. **Property Payoff Services Agreement**: Property payoff services terms.

454. **Property Allocation Services Agreement**: Property allocation services terms.

455. **Property Lease Extension Services Agreement**: Property lease extension services terms.

456. **Property Mediation Services Agreement**: Property mediation services terms.

457. **Property Collaboration Services Agreement**:

Property collaboration services terms.

458. **Property Joint Ownership Services Agreement**: Property joint ownership services terms.

459. **Property Settlement Services Agreement**: Property settlement services terms.

460. **Property Mortgage Deed Services Agreement**: Property mortgage deed services terms.

461. **Property Assignment Services Agreement**: Property assignment services terms.

462. **Property Option Services Agreement**: Property option services terms.

463. **Property Title Deed Services Agreement**: Property title deed services terms.

464. **Property Buy-Sell Services Agreement**: Property buy-sell services terms.

465. **Property Insolvency Services Agreement**: Property insolvency services terms.

466. **Property Bankruptcy Services Agreement**: Property bankruptcy services terms.

467. **Property Receivership Services Agreement**: Property receivership services terms.

468. **Property Investment Services Agreement**: Property investment services terms.

469. **Property Payment Plan Services Agreement**: Property payment plan services terms.

470. **Property Leaseback Services Agreement**: Property leaseback services terms.471. **Property Partition Services Agreement**: Property partition services terms.

472. **Property Divestiture Services Agreement**: Property divestiture services terms.

473. **Property Receivable Services Agreement**: Property receivable services terms.

474. **Property Authorization Services Agreement**: Property authorization services terms.

475. **Property Control Services Agreement**: Property control services terms.

476. **Property Exit Services Agreement**: Property exit services terms.

477. **Property Trade Services Agreement**: Property trade services terms.

478. **Property Enforcement Services Agreement**: Property enforcement services terms.

479. **Property Cost Sharing Services Agreement**: Property cost sharing services terms.

480. **Property Lease Extension Services Agreement**: Property lease extension services terms.

481. **Property Mediation Services Agreement**: Property mediation services terms.

482. **Property Trading Services Agreement**: Property trading services terms.

483. **Property Tax Sharing Services Agreement**: Property tax sharing services terms.

484. **Property Grant Services Agreement**: Property grant services terms.

485. **Property Allocation Services Agreement**: Property allocation services terms.

486. **Property Risk Management Services Agreement**: Property risk management services terms.

487. **Property Withdrawal Services Agreement**: Property withdrawal services terms.

488. **Property Donation Services Agreement**: Property donation services terms.

489. **Property Insurance Coverage Services Agreement**: Property insurance coverage services terms.

490. **Property Warranty Deed Services Agreement**: Property warranty deed services terms.

491. **Property Swap Services Agreement**: Property swap services terms.

492. **Property Capitalization Services Agreement**: Property capitalization services terms.

493. **Property Beneficiary Services Agreement**: Property beneficiary services terms.494. **Property Title Transfer Services Agreement**: Property title transfer services terms.

495. **Property Financing Services Agreement**: Property financing services terms.

496. **Property Distribution Services Agreement**: Property distribution services terms.

497. **Property Deed of Assignment Services Agreement**: Property deed of assignment services terms.

498. **Property Payment Services Agreement**: Property payment services terms.

499. **Property Support Services Agreement**: Property support services terms.

500. **Property Separation Services Agreement**: Property separation services

terms.
Hybrid Index Annuities
Contingent Deferred Annuities (CDAs)
Private Placement Life Insurance (PPLI)
Deferred Income Annuities (DIAs)
Corporate-Owned Life Insurance (COLI)
Bank-Owned Life Insurance (BOLI)
Collateralized Debt Obligations (CDOs)
Collateralized Loan Obligations (CLOs)
Tokenized Real Estate Investment Trusts (REITs)
Decentralized Finance (DeFi) Lending Pools
Real Estate Token Offerings (RETOs)
Pension-Backed Loans
Digital Asset Lending Agreements
Convertible Bond Structures
Hedge Fund Participation Units
Municipal Bond Ladders
Structured Treasury Note Instruments
Synthetic Equity Swaps
Royalty-Based Investment Agreements
Blockchain Escrow Agreements
Qualified Opportunity Fund Agreements
Credit Default Swaps
Sovereign Debt Participation Contracts
Shared Appreciation Agreements
Portfolio Margin Loans
On-Chain Collateral Vaults
Enterprise Revenue Sharing Agreements
Family Banking Trusts
Cash Balance Pension Plans
Business Development Company (BDC) Structures
Indexed Savings Certificates
Private Collateral Pools
Actuarially Managed Trusts
Trust-Owned Contracts with Embedded Riders
Universal Life Policies with Executive Bonus Plans
Strategic Partner Equity Agreements
Synthetic Real Estate Derivatives
Funded Reinsurance Structures
Capital Lease Financing
Private Credit Facility Agreements
NFT-Backed Loan Contracts
Venture Capital Participation Notes
Accelerated Benefit Riders (ABRs)
Retained Death Benefit Agreements
Microfinance Participation Loans
Forward Commitment Contracts
Alternative Liquidity Agreements (ALAs)
Multi-Class Equity Waterfall Agreements
Digital Token Vault Agreements
Blockchain Smart Contract Escrows
InsurTech-Managed Wealth Pods
Indexed CD Products with Put/Call Features
Securities-Based Lines of Credit (SBLOCs)
Income Share Agreements (ISAs)
Chartered Lending Trusts
Project Finance Waterfall Agreements
Business Continuation Buy/Sell Agreements
High-Yield Bond Laddering Structures
Private Insurance Captive Structures
Guaranteed Issue Term Conversion Contracts
Intellectual Property-Backed Lending Instruments
Charitable Lead Trusts (CLTs)
Charitable Remainder Trusts (CRTs)
Tax Allocation Swap Agreements
Real Asset Participation Trusts
Equity Collar Strategies
Zero-Coupon Life Settlement Vehicles
Synthetic Life Insurance Pools
Proprietary Index Allocation Contracts
Customized Glidepath Investment Agreements
Portfolio Risk-Bucketing Agreements
Corporate Split-Dollar Agreements
Interest Rate Swap Agreements
Value-Sharing Family Office Contracts
Viatical Settlement Vehicles
Private Equity Note Participation Contracts
Deferred Distribution Agreements
Alternative Investment Trust Deeds
Self-Directed IRA Trust Agreements
Endowment-Based Lending Pools
Healthcare Savings Hedge Agreements
Volatility-Controlled Structured Products
Long-Duration Reinsurance Participations
Policy-Based Line of Credit Agreements
Credit Enhancement Bonds
Off-Balance Sheet Leaseback Trusts
Income-Indexed Tontine Structures
Capital Recovery Bonds
Maturity-Agnostic Escrow Trusts
Synthetic Bank Participation Loans
AI-Managed Investment Accounts
Income Acceleration Sidecars
Tokenized Annuity Pools
Smart Index Algorithmic Trusts
Stochastic Risk Pooling Contracts
Hybrid Retirement Income Bridges
Deferred Surrender Bonus Pools
Insurance-Linked Securities (ILS)
Mortgage-Payoff Indexed Units
Mortgage Conversion Participation Pools
Hybrid Index Annuities
Contingent Deferred Annuities (CDAs)
Private Placement Life Insurance (PPLI)
Deferred Income Annuities (DIAs)
Corporate-Owned Life Insurance (COLI)
Bank-Owned Life Insurance (BOLI)
Collateralized Debt Obligations (CDOs)
Collateralized Loan Obligations (CLOs)
Tokenized Real Estate Investment Trusts (REITs)
Decentralized Finance (DeFi) Lending Pools
Real Estate Token Offerings (RETOs)
Pension-Backed Loans
Digital Asset Lending Agreements
Convertible Bond Structures
Hedge Fund Participation Units
Municipal Bond Ladders
Structured Treasury Note Instruments
Synthetic Equity Swaps
Royalty-Based Investment Agreements
Blockchain Escrow Agreements
Qualified Opportunity Fund Agreements
Credit Default Swaps
Sovereign Debt Participation Contracts
Shared Appreciation Agreements
Portfolio Margin Loans
On-Chain Collateral Vaults
Enterprise Revenue Sharing Agreements
Family Banking Trusts
Cash Balance Pension Plans
Business Development Company (BDC) Structures
Indexed Savings Certificates
Private Collateral Pools
Actuarially Managed Trusts
Trust-Owned Contracts with Embedded Riders
Universal Life Policies with Executive Bonus Plans
Strategic Partner Equity Agreements
Synthetic Real Estate Derivatives
Funded Reinsurance Structures
Capital Lease Financing
Private Credit Facility Agreements
NFT-Backed Loan Contracts
Venture Capital Participation Notes
Accelerated Benefit Riders (ABRs)
Retained Death Benefit Agreements
Microfinance Participation Loans
Forward Commitment Contracts
Alternative Liquidity Agreements (ALAs)
Multi-Class Equity Waterfall Agreements
Digital Token Vault Agreements
Blockchain Smart Contract Escrows
InsurTech-Managed Wealth Pods
Indexed CD Products with Put/Call Features
Securities-Based Lines of Credit (SBLOCs)
Income Share Agreements (ISAs)
Chartered Lending Trusts
Project Finance Waterfall Agreements
Business Continuation Buy/Sell Agreements
High-Yield Bond Laddering Structures
Private Insurance Captive Structures
Guaranteed Issue Term Conversion Contracts
Intellectual Property-Backed Lending Instruments
Charitable Lead Trusts (CLTs)
Charitable Remainder Trusts (CRTs)
Tax Allocation Swap Agreements
Real Asset Participation Trusts
Equity Collar Strategies
Zero-Coupon Life Settlement Vehicles
Synthetic Life Insurance Pools
Proprietary Index Allocation Contracts
Customized Glidepath Investment Agreements
Portfolio Risk-Bucketing Agreements
Corporate Split-Dollar Agreements
Interest Rate Swap Agreements
Value-Sharing Family Office Contracts
Viatical Settlement Vehicles
Private Equity Note Participation Contracts
Deferred Distribution Agreements
Alternative Investment Trust Deeds
Self-Directed IRA Trust Agreements
Endowment-Based Lending Pools
Healthcare Savings Hedge Agreements
Volatility-Controlled Structured Products
Long-Duration Reinsurance Participations
Policy-Based Line of Credit Agreements
Credit Enhancement Bonds
Off-Balance Sheet Leaseback Trusts
Income-Indexed Tontine Structures
Capital Recovery Bonds
Maturity-Agnostic Escrow Trusts
Synthetic Bank Participation Loans
AI-Managed Investment Accounts
Income Acceleration Sidecars
Tokenized Annuity Pools
Smart Index Algorithmic Trusts
Stochastic Risk Pooling Contracts
Hybrid Retirement Income Bridges
Deferred Surrender Bonus Pools
Insurance-Linked Securities (ILS)
Mortgage-Payoff Indexed Units
Mortgage Conversion Participation Pools

The foregoing descriptions of specific implementations have been presented for purposes of illustration and description. They are not intended to be exhaustive or to limit the invention to the precise forms disclosed, and modifications and variations are possible in view of the above teaching. The exemplary implementations were chosen and described to best explain the principles of the invention and its practical application, to thereby enable others skilled in the art to best utilize the invention and its implementations with modifications as suited to the use contemplated.

It is therefore submitted that the invention has been shown and described in the most practical and exemplary implementations. It should be recognized that departures may be made which fall within the scope of the invention. With respect to the description provided herein, it is submitted that the optimal features of the invention include variations in size, materials, shape, form, function, manner of operation, assembly, and use. All structures, functions, and relationships equivalent or essentially equivalent to those disclosed are intended to be encompassed by the invention.

The present invention is intended to be modular and technology-agnostic. Any investment or financial structure capable of supporting collateralized borrowing, interest crediting, value appreciation, or policy-based returns—including future-developed equivalents—may be substituted without departing from the scope of the invention. This includes tokenized products, decentralized yield instruments, or proprietary financial platforms not yet commercially available.

The methodology described herein may be executed through any financial institution, insurance carrier, trust platform, or managed entity. Any attempt to reproduce the structure under alternate terminology, policy packaging, or platform wrapper is considered within the scope of this invention and protected as such.

1. A method, comprising:
receiving client information and data on a plurality of income-producing assets;
generating a plurality of equity contracts and client risk factors based on the client information;
retrieving equity of a first real estate property in response to execution of at least one of the plurality of equity contracts by a first external computing device;
selecting and funding at least one of the plurality of income-producing assets with the equity based on the client risk factors; and
deducting at least a portion of revenue from at least one of the plurality of income-producing assets as an interest payment.

2. The method of claim 1, wherein generating the plurality of equity contracts comprises generating the plurality of equity contracts that includes at least one of a mortgage term and an interest term.

3. The method of claim 2, wherein each of the mortgage term and the interest term ranges from 0 to 2.99%.

4. The method of claim 1, wherein generating the client risk factors comprises generating client risk factors based on tolerance to volatility.

5. The method of claim 1, wherein the data on the income-producing assets includes at least one of liquidity, principal protection, expected returns, cash flow, and arbitrage opportunities.

6. The method of claim 1, wherein selecting at least one of the plurality of income-producing assets comprises:
generating a risk grade based on the data on the plurality of income-producing assets; and
selecting at least one of the plurality of income-producing assets with the risk grade based on the client risk factors and an interest term.

7. The method of claim 1, further comprising:
matching client risk factors from at least one second external computing device;
retrieving equity of a second real estate property in response to execution of at least one of the plurality of equity contracts by the second external computing device; and
funding at least one of the plurality of income-producing assets with the equity from the first external computing device and the second external computing device.

8. The method of claim 1, wherein deducting at least a portion of revenue comprises reducing a mortgage term to zero based on the revenue generated from at least one of the plurality of income-producing assets.

9. A system, comprising:
one or more processing units, the one or more processing units configured to:
receive client information and data on a plurality of income-producing assets;
generate a plurality of equity contracts and client risk factors based on the client information;
retrieve equity of a first real estate property in response to execution of at least one of the plurality of equity contracts by a first external computing device;
select and fund at least one of the plurality of income-producing assets with the equity based on the client risk factors; and
deduct at least a portion of revenue from at least one of the plurality of income-producing assets as an interest payment.

10. The system of claim 9, wherein the one or more processing units are configured to generate the plurality of equity contracts to include at least one of a mortgage term and an interest term.

11. The system of claim 10, wherein the one or more processing units are configured to limit each of the mortgage term and the interest term ranges from 0 to 2.99%.

12. The system of claim 10, wherein the one or more processing units are configured to generate client risk factors based on tolerance to volatility.

13. The system of claim 9, wherein the one or more processing units are configured to identify the data on the income-producing assets to include at least one of liquidity, principal protection, expected returns, cash flow, and arbitrage opportunities.

14. The system of claim 9, wherein the one or more processing units are configured to:
generate a risk grade based on the data on the plurality of income-producing assets; and
select at least one of the plurality of income-producing assets with the risk grade based on the client risk factors and an interest term.

15. The system of claim 9, wherein the one or more processing units are further configured to:
match client risk factors from at least one second external computing device;
retrieve equity of a second real estate property in response to execution of at least one of the plurality of equity contracts by the second external computing device; and
fund at least one of the plurality of income-producing assets with the equity from the first external computing device and the second external computing device.

16. The system of claim 9, wherein the one or more processing units are configured to deduct at least a portion of revenue comprises reducing a mortgage term to zero based on the revenue generated from at least one of the plurality of income-producing assets.

17. A method, comprising:
generating an interest free mortgage based on receipt of at least one contract from at least one external computing device;
generating an equity loan of at least one real estate property based on a difference in value between a market value of the at least one real estate property and the interest free mortgage;
funding at least one of plurality of income-producing assets from the equity loan in response to at least one of the plurality of income-producing assets having a return on investment (ROI) exceeding a threshold value; and
transferring at least a portion of the ROI to pay an interest payment on at least one of the interest free mortgage and the equity loan.

18. The method of claim 17, wherein generating the interest free mortgage comprises adjusting a payment of principal on the interest free mortgage based on a risk factor.

19. The method of claim 18, wherein the risk factor is at least one of a credit score and the difference in value between the market value of the at least one real estate property and the interest free mortgage.

20. The method of claim 17, further comprising:
receiving a rebate based on the equity loan; and
generating a life insurance policy assigned to the at least one external computing device.
